(19) United States
(12) Patent Application Publication
(10) Pub. No.: US 2024/0425428 A1
(43) Pub. Date: Dec. 26, 2024

(54) FERTILIZER COMPOSITIONS AND METHODS OF USING SAME

(71) Applicant: MIGAL GALILEE RESEARCH INSTITUTE LTD., Kiryat Shmona (IL)

(72) Inventors: Michael LITAOR, Rosh Pina (IL); Iris ZOHAR, Zippori (IL)

(73) Assignee: MIGAL GALILEE RESEARCH INSTITUTE LTD., Kiryat Shmona (IL)

(21) Appl. No.: 18/274,060

(22) PCT Filed: Jan. 25, 2022
(86) PCT No.: PCT/IL2022/050103

§ 371 Date: Jul. 25, 2023

Related U.S. Application Data
(60) Provisional application No. 63/211,592, filed on Jun. 17, 2021.

(30) Foreign Application Priority Data
Jan. 25, 2021 (WO) PCT/IL2021/050078

(51) Int. Cl. C05F 7/00; B01J 20/16; B01J 20/28; C02F 1/28; C02F 101/10; C05B 7/00; C05D 9/02; C05G 5/10

(52) U.S. Cl. CPC C05F 7/005; B01J 20/16; B01J 20/28004; B01J 20/28016; C02F 1/288; C05B 7/00; C05D 9/02; C05G 5/10; C02F 1/281; C02F 2101/105

(57) ABSTRACT

A method of treating water contaminated with a phosphorus specie and a method for manufacturing a fertilizer are provided.

### CROSS-REFERENCE TO RELATED APPLICATIONS

This application claims the benefit of priority of PCT Patent Application No. PCT/IL2021/050078, titled “FERTILIZER COMPOSITIONS AND METHODS OF USING SAME”, filed Jan. 25, 2021, and of U.S. Provisional Patent Application No. 63/211,592, titled “METHODS OF REMOVING PHOSPHATE FROM WASTEWATER”, filed Jun. 17, 2021. The contents of both applications are incorporated herein by reference in their entirety.

### FIELD OF THE INVENTION

The invention relates generally to the field of phosphorus enriched compositions, and methods of production and uses thereof.

### BACKGROUND

Phosphorus (P) is a crucial macro-nutrient in agriculture, but P resources are non-renewable, and a common prediction suggests significant P reserves dwindling in 100-150 years. This has prompted many studies in recent decades to search for new P recycling means. Agricultural wastewaters (WWs) are usually rich in organics and P along with other nutrients and require pre-treatment, including phosphorus removal, before their discharge to municipal WW treatment facilities or to the environment. A potential means to recover P from WWs are the use of water treatment residuals (WTRs) formed following treating drinking or desalination plant's feed water with coagulants such as ferric chloride (Fe-WTRs). Due to the significant affinity of various metal oxides (such as Mg, Fe, and Ca-oxides) to phosphate, Fe-WTRs can be utilized for recovery of phosphorus specie (e.g. phosphate) from P-containing wastewater streams while utilizing a refuse (i.e., WTR) that otherwise would be landfilled.

Furthermore, the inventors postulated, that metal oxide based inorganic compositions (e.g. Fe-WTR) enriched with phosphorus species might be applied as a potential P fertilizer product that could help to offset future dwindling P resources.

The foregoing examples of the related art and limitations related therewith are intended to be illustrative and not exclusive. Other limitations of the related art will become apparent to those of skill in the art upon a reading of the specification.

### SUMMARY

The following embodiments and aspects thereof are described and illustrated in conjunction with systems, tools and methods which are meant to be exemplary and illustrative, not limiting in scope.

In one aspect of the invention, there is provided a composition comprising a sorbent enriched with organic material comprising a phosphorus specie, wherein the sorbent comprises between 5 and 40% of an iron specie between 5 and 50% of a calcium specie, and optionally at most 9% of aluminum specie by total dry weight of the sorbent; and the composition comprises between 5 and 40% of organic material; and between 1 and 10% of the phosphorus specie; wherein at least 10% w/w of the phosphorus specie is phytoavailable.

In one embodiment, any one of the iron specie, the calcium specie and the aluminum specie comprises an oxide, a hydroxide, a salt, or any combination thereof.

In one embodiment, the sorbent comprises at least 50% water treatment residuals (WTR) by dry weight of the sorbent.

In one embodiment, the sorbent further comprises at least one of (i) between 0.1 and 5% of a magnesium specie, and (ii) between 10 and 40% of silica, by total dry weight of the sorbent.

In one embodiment, the magnesium specie comprises magnesium oxide, magnesium hydroxide, a magnesium salt, or any combination thereof.

In one embodiment, the composition is in from of a particulate matter.

In one embodiment, the particulate matter has an average particle size between 10 μm and 1000 μm.

In one embodiment, the particulate matter has a surface area of between 100 and 2000 m² g⁻¹.

In one embodiment, the phosphorus specie comprises an inorganic phosphate, an organic phosphate or both.

In one embodiment, the inorganic phosphate is selected from the group consisting of: a phosphate, a diphosphate, and a triphosphate including any combination or a salt thereof.

In one embodiment, the organic phosphate is selected from the group consisting of: a phosphate ester, a phosphodiester, and a phosphotriester, including any combination or a salt thereof.

In one embodiment, the composition further comprises an additive.

In one embodiment, a water content of the composition is between 0.1 and 10%.

In one embodiment, at least 90% w/w of the phosphorus specie is stably bound to the sorbent.

In one embodiment, at least 50% w/w of the phosphorus specie is phytoavailable.

In another aspect, there is a fertilizer, comprising a fertilizing effective amount of a composite comprising a sorbent enriched with organic material comprising a phosphorus specie, wherein the sorbent comprises between 5 and 40% of an iron specie, between 5 and 50% of a calcium specie, and optionally at most 9% of aluminum specie by total dry weight of the sorbent; the composite comprises between 5 and 40% of organic material; and between 1 and 10% of the phosphorus specie; wherein at least 10% w/w of the phosphorus specie is phytoavailable.

In one embodiment, the sorbent comprises at least 50% water treatment residuals (WTR) by dry weight of the sorbent.

In one embodiment, the sorbent further comprises at least one of (i) between 0.1 and 5% of a magnesium specie, and (ii) between 10 and 40% of silica, by total dry weight of the sorbent.

In one embodiment, any one of the iron specie, the calcium specie and the aluminum specie is selected from the group consisting of a metal oxide, a metal hydroxide, and a metal salt or any combination thereof.

In one embodiment, the magnesium specie comprises magnesium oxide, magnesium hydroxide, a magnesium salt, or any combination thereof.

In one embodiment, the composite is in from of a particulate matter.

In one embodiment, the particulate matter has an average particle size between 10μm and 1000 μm.

In one embodiment, the fertilizing effective amount comprises between 0.1 and 50 ton of the composite to a hectare soil.

In one embodiment, the phosphorus specie comprises an inorganic phosphate, an organic phosphate or both.

In one embodiment, inorganic phosphate is selected from the group consisting of: a phosphate, a diphosphate, and a triphosphate including any combination or a salt thereof.

In one embodiment, the organic phosphate is selected from the group consisting of: a phosphate ester, a phosphodiester, and a phosphotriester, including any combination or a salt thereof.

In one embodiment, a water content of the composite is between 0.1 and 10%.

In one embodiment, at least 90% w/w of the phosphorus specie is stably bound to the sorbent.

In one embodiment, at least 50% w/w of the phosphorus specie is phytoavailable.

In one embodiment, the fertilizer comprises at least one of N and K, including any salt or a derivative thereof.

In one embodiment, the fertilizer further comprises a micro element selected from the group consisting of Mg, Ca, S, Fe, Mn, Zn, B, Cu, Mo, and Si, including any salt, a derivative or a combination thereof.

In one embodiment, the fertilizer further comprises an agriculturally acceptable carrier.

In one embodiment, the fertilizer is characterized by an enhanced release of the phosphorus specie upon contacting the fertilizer with a soil, wherein the enhanced release is greater by at least 10% compared to a control.

In another aspect, there is a method for treating water contaminated with a phosphorus specie, comprising contacting the water with a sorbent under appropriate conditions, thereby reducing a content of the phosphorus specie within the water; wherein the sorbent comprises between 5 and 40% of an iron specie, between 5 and 50% of a calcium specie, and optionally at most 9% of aluminum specie by total dry weight of the sorbent, and wherein the sorbent comprises at least 50% water treatment residuals (WTR) by dry weight of the sorbent.

In one embodiment, the sorbent further comprises at least one of (i) between 0.1 and 5% of a magnesium specie, and (ii) between 10 and 40% of silica, by total dry weight of the sorbent.

In one embodiment, the appropriate conditions comprise (i) incubation time sufficient for reducing the content of the of the phosphorus specie within the water by at least 50%, (ii) temperature of between 5 and 50° C.

In one embodiment, the contacting comprises agitating the water with the sorbent.

In one embodiment, the method is for enriching the sorbent with the phosphorus specie.

In another aspect, there a method for enriching a soil with an element, comprises contacting a fertilizing effective amount of the fertilizer of the invention with the soil.

In one embodiment, the element is selected from the group consisting of P, Fe, N and K including any salt or a combination thereof.

In one embodiment, the enriching comprises increasing a w/w concentration of the element within the soil by at least 10% compared to a solid fertilizer with the same total phosphorus content.

In one embodiment, the element is a phytoavailable element.

In one embodiment, the method is for increasing a concentration of the element within a plant or a part of the plant.

In one embodiment, the method is for increasing any one of: (i) a yield of a plant, (ii) a growth of a plant or both (i) and (II).

In one embodiment, the fertilizing effective amount is between 0.1 and 50 ton/Hectare.

In one embodiment, the fertilizer is capable of enhancing (i) a plant yield, (ii) a plant growth or both (i) and (ii), and wherein the enhancing is by at least 10% compared to a control.

In another aspect, there is provided a method for treating water contaminated with a phosphorus specie, the method comprising: pretreating the water with a nano-composite, under conditions sufficient for removal of at least 80% of suspended solids from the water, thereby obtaining a clarified water; contacting the clarified water with a phosphorus sorbent under conditions sufficient for a substantial removal the phosphorus specie from the water, thereby obtaining reclaimed water.

In one embodiment, the method further comprises separating the phosphorus sorbent from the reclaimed water.

In one embodiment, separating is via any of: filtration, precipitation, centrifugation, sedimentation or any combination thereof.

In one embodiment, the method comprises a primary sedimentation of the water, wherein the primary sedimentation is performed prior to the pretreating of the water.

In one embodiment, the phosphorus sorbent comprises a WTR, a layered double hydroxide, a layered double oxide, or any combination thereof.

In one embodiment, the phosphorus sorbent is in a form of a particulate matter having an average particle size between 10 μm and 1000 μm.

In one embodiment, the nano-composite comprises a clay mineral bound to a cationic polymer.

In one embodiment, the clay mineral comprises: (i) a clay mineral selected from the group consisting of sepiolite, palygorskite, attapulgite, smectite, montmorillonite, bentonite, hectorite, kaolinite, halloysite, or vermiculite; (ii) a non-clay mineral selected from the group consisting of including quartz, diatomaceous earth, and zeolites; or (iii) a mixture of (i) and (ii).

In one embodiment, the cationic polymer comprises any one of poly (diallyldimethylammonium) chloride (poly-DADMAC), a cationic polyacrylamide, polyethyleneimine; (ii) a polyquaternium; (iii) cationic polysaccharide; (iv) styrene-based cationic polymers; including nay copolymer or any combination thereof.

In one embodiment, pretreating comprises contacting the water with the composite for a time period of at least 1 minute and at a temperature of between 5 and 50° C.

In one embodiment, pretreating comprises contacting the water with the composite at a w/w concentration of the composite within the water is at least 0.1%.

In one embodiment, the clarified water is characterized by turbidity of at most 200 NTU.

In one embodiment, a total phosphorus (TP) content of the reclaimed water is below 2 mg/L.

In one embodiment, the appropriate conditions comprise: (i) incubation time between 10 min and 5 h, and (ii) temperature of between 5 and 50° C.

In one embodiment, contacting comprises a w/v ratio of the phosphorus sorbent to the clarified water of at least 0.5 g/L.

In one embodiment, the phosphorus sorbent is or comprises Fe-WTR.

In another aspect, there is provided a method for manufacturing the fertilizer of any the invention, comprising pretreating water contaminated with a phosphorus specie with a nano-composite, under conditions sufficient for removal of at least 80% of suspended solids from the water, thereby obtaining a clarified water; contacting the clarified water with a sorbent under conditions sufficient for removal of at least 60% of the phosphorus specie from the water, thereby obtaining the fertilizer; wherein the sorbent comprises between 5 and 40% of an iron specie, between 5 and 50% of a calcium specie, and optionally at most 9% of aluminum specie by total dry weight of the sorbent, and wherein the sorbent comprises at least 50% water treatment residuals (WTR) by dry weight of the sorbent.

In one embodiment, the method further comprises separating the fertilizer from the clarified water and optionally comprises a step of drying the fertilizer.

In one embodiment, separating is via any of: filtration, precipitation, centrifugation, sedimentation or any combination thereof.

In one embodiment, the method comprises a primary sedimentation of the water, wherein the primary sedimentation is performed prior to the pretreating of the water.

In one embodiment, the sorbent further comprises at least one of (i) between 0.1 and 5% of a magnesium specie, and (ii) between 10 and 40% of silica, by total dry weight of the sorbent.

In one embodiment, the sorbent is in a form of a particulate matter having an average particle size between 10 μm and 1000 μm.

In one embodiment, the nano-composite comprises a clay mineral bound to a cationic polymer.

In one embodiment, the clay mineral comprises: (i) a clay mineral selected from the group consisting of sepiolite, palygorskite, attapulgite, smectite, montmorillonite, bentonite, hectorite, kaolinite, halloysite, or vermiculite; (ii) a non-clay mineral selected from the group consisting of including quartz, diatomaceous earth, and zeolites; or (iii) a mixture of (i) and (ii).

In one embodiment, the cationic polymer comprises any one of poly (diallyldimethylammonium) chloride (poly-DADMAC), a cationic polyacrylamide, polyethyleneimine; (ii) a polyquaternium; (iii) cationic polysaccharide; (iv) styrene-based cationic polymers; including nay copolymer or any combination thereof.

In one embodiment, pretreating comprises contacting the water with the composite for a time period of at least 1 minute and at a temperature of between 5 and 50° C.

In one embodiment, pretreating comprises contacting the water with the composite at a w/w concentration of the composite within the water is at least 0.1%.

In one embodiment, clarified water is characterized by turbidity of at most 200 NTU.

In one embodiment, a total dissolved phosphate (TDP) content of the clarified water is at least 90%, as compared to a TDP content of the water.

In one embodiment, appropriate conditions comprise: (i) incubation time between 10 min and 5 h, and (ii) temperature of between 5 and 50° C.

In one embodiment, contacting comprises a w/v ratio of the sorbent to the clarified water of at least 1 g/L.

In one embodiment, the phosphorus specie comprises an inorganic phosphate, an organic phosphate or both.

In one embodiment, the inorganic phosphate is selected from the group consisting of: a phosphate, a diphosphate, and a triphosphate including any combination or a salt thereof.

In one embodiment, the organic phosphate is selected from the group consisting of: a phosphate ester, a phosphodiester, and a phosphotriester, including any combination or a salt thereof.

In one embodiment, the sorbent is the sorbent of the invention such as Fe-WTR based sorbent.

In addition to the exemplary aspects and embodiments described above, further aspects and embodiments will become apparent by study of the following detailed description.

### BRIEF DESCRIPTION OF THE FIGURES

FIG. 1 is a graph representing soluble reactive phosphate (SRP) and total dissolved phosphate (TDP) removal percentage from the dairy wastewater in different doses Fe-WTR per 1 L wastewater.

FIG. 2 is a bar graph representing TDP concentration in 0.01M KCl extracts obtained from Fe-WTR, Aluminum-based WTR (Al-WTR) and synthetic adsorbents (layered double hydroxide (LDH) based materials) LDH-Ne and LDH-Fr. Adsorbents are as follows: untreated adsorbents (Original); adsorbents enriched with inorganic phosphate (Pi-load); adsorbents enriched with dairy wastewater pretreated by either centrifugation (WW-Centri) or by nanocomposite coagulants (WW-Nano).

FIGS. 3A-B are bar graphs representing tomato yield (FIG. 3A) and a number of tomatoes (FIG. 3B) upon treatment with a solid fertilizer (commercial P solid fertilizer, “Osmocote 3-4”); and with an exemplary composition of the invention (100 g per 10 L soil (FeO_100) and WW-Fe/O-WTR in 150 g per 10 L soil (FeO_150)). By using the Boxplot graph the main tendency of the data is emphasized, the box shows the Interquartile Range (IQR), the horizontal line represents the median, the tails delimit all the data except for the extreme values defined as farther than IQR*1.5 from the interquartile range and marked by Y°.

FIG. 4 is a flowchart illustrating an exemplary method of manufacturing a composition of the invention in some embodiments thereof.

### DETAILED DESCRIPTION

The present invention in some embodiments thereof is at least partially based on a surprising finding, that a fertilizer, as disclosed herein, containing up to 10% or even up to 5% by weight of the total phosphorus, have been successfully implemented for soil enrichment with phytoavailable phosphorus specie, wherein the commercially available solid fertilizers require a substantially higher phosphorus content of about 20% by weight. Furthermore, the yield of the cultivated plant was either the same or even increased upon implementation of a fertilizer disclosed herein (with the total phosphorus content of up to 5% by weight), compared to a commercially available solid fertilizer with the total phosphorus content of about 20% w/w.

According to one aspect there is provided a composition comprising a sorbent enriched with an organic material comprising a phosphorus specie, wherein the sorbent comprises between 5 and 40% of an iron specie, between 5 and 50% of calcium specie; wherein the composition comprises between 5 and 40% of organic material, and between 1 and 10% weight per weight (w/w) of the phosphorus specie. In some embodiments, at least 5%, at least 10%, at least 20%, at least 30%, at least 50% w/w of the phosphorus specie within the composition is a phytoavailable phosphorus specie. In some embodiments, the sorbent is substantially devoid of aluminum oxide and/or aluminum hydroxide. In some embodiments, the sorbent comprises at most 9% of aluminum oxide and/or aluminum hydroxide by total dry weight of the sorbent. In some embodiments, the sorbent is substantially devoid of an aluminum specie (e.g. an aluminum cation, an aluminum salt, aluminum oxide etc.). In some embodiments, the sorbent comprises at most 9% of the aluminum specie by total dry weight of the sorbent. In some embodiments, the composition of the invention comprises a sorbent enriched by the organic material, wherein enriched is by at least 10%, at least 20%, at least 30%, at least 50% by weight, including any range between, compared to the non-enriched (e.g. pristine) sorbent.

In some embodiments, the iron specie comprises an iron salt and/or an iron oxide. In some embodiments, the iron specie comprises an iron cation. In some embodiments, the iron salt comprises an iron cation (a divalent iron cation and/or a trivalent iron cation) and a counter anion. In some embodiments, the iron specie comprises Fe₂(OR)₃, and/or Fe(OR)₃, wherein each R is independently H or is absent. In some embodiments, the iron salt comprises Fe₂(OH)₃ and/or Fe(OH)₃.

In some embodiments, the calcium specie comprises a calcium salt, calcium oxide or both. In some embodiments, the calcium specie comprises a calcium cation. In some embodiments, the calcium salt comprises a calcium cation (a divalent calcium cation) and a counter anion. In some embodiments, the calcium specie comprises CaOR, wherein R is H or is absent. In some embodiments, the calcium specie comprises Ca(OH)₂.

In some embodiments, the counter anion is selected from the group comprising any one of halide (e.g. chloride, fluoride, bromine), hydroxide, sulfate, sulfite, nitrate, acetate, carbonate, citrate, phosphate, or any combination thereof. Other anions are well-known in the art.

In some embodiments, the iron salt comprises FeCl₃. In some embodiments, the iron salt comprises FeCl₃, Fe₂(OH)₃, Fe(OH)₃ or any combination thereof. In some embodiments, the iron salt comprises iron oxide (e.g. Fe(II) oxide, and/or Fe(III) oxide), iron hydroxide, iron oxyhydroxide or any combination thereof. Various iron oxides and/or iron oxyhydroxides are well-known in the art, such as mixed Fe(II) and Fe(III) oxides, etc.

In some embodiments, the calcium salt comprises CaCO₃. In some embodiments, the calcium salt comprises CaCO₃, Ca(OH)₂, CaO, CaCl₂ or any combination thereof.

In some embodiments, the sorbent comprises at most 10%, at most 9%, at most 8%, at most 7%, at most 6%, at most 5%, at most 3%, of the aluminum specie (e.g. aluminum oxide and/or aluminum hydroxide) by total dry weight of the sorbent including any range or value therebetween.

In some embodiments, the composition of the invention is a solid composition. In some embodiments, the composition comprises a plurality of particles. In some embodiments, the composition is a slurry or sludge.

In some embodiments, the composition comprises a sorbent. In some embodiments, a weight ratio of the sorbent within the composition is at least 80%, at least 85%, at least 90%, at least 92%, at least 95%, at least 97%, at least 99%, including any range or value therebetween, by weight of the composition. In some embodiments, the composition comprises a sorbent. In some embodiments, a weight ratio of the sorbent within the composition is at most 99.9%, at most 99.5%, at most 99%, at most 98%, at most 95%, at most 92%, at most 90%, at most 85%, at most 80%, including any range or value therebetween, by weight of the composition.

In some embodiments, the sorbent of the invention is a solid. In some embodiments, the sorbent is in a form of a particulate matter. In some embodiments, the sorbent is capable of binding a phosphorous specie, wherein the phosphorous specie is as described herein. In some embodiments, the sorbent is capable of adsorbing the phosphorous specie on or within a sorbent particle. In some embodiments, adsorbing comprises chemisorption, physisorption or both. In some embodiments, the sorbent is capable of entrapment the phosphorous specie on the outer surface of the sorbent particle. In some embodiments, the sorbent is capable of entrapment the phosphorous specie within the sorbent particle.

In some embodiments, the composition comprises the sorbent bound to the phosphorous specie. In some embodiments, the composition comprises the sorbent enriched with the phosphorous specie. In some embodiments, the sorbent is in a form of a matrix (e.g. a porous bulk), wherein the phosphorous specie is bound to the surface and/or to the interior of the matrix. In some embodiments, the sorbent is characterized by an enhanced porosity. In some embodiments, the sorbent is characterized by porosity of between 10 and 30%. In some embodiments, the composition comprises the phosphorous specie entrapped on or within the sorbent. In some embodiments, the composition comprises the phosphorous specie entrapped within a plurality of pores within the sorbent (e.g. the sorbent particle).

In some embodiments, the phosphorous specie is bound to the sorbent by any one of: a labile bond (e.g. being extractable by MgCl2 solution, as described herein), a moderately labile bond (e.g. being extractable by dithionite-citrate solution as described herein), and a strong bond (e.g. being extractable by Na-acetate solution as described herein). In some embodiments, the phosphorous specie bound by the labile bond is substantially located on the surface of the sorbent (or matrix). In some embodiments, the phosphorous specie bound by the moderately labile bond and/or by the strong bond is substantially located within the interior of the sorbent (or matrix). In some embodiments, the phosphorous specie (e.g. organic phosphorus specie) is covalently bound to the sorbent (e.g. to the organic material of the sorbent).

In some embodiments, binding (e.g. via a physisorption or a chemisorption) of a phosphorous specie to the sorbent is by any one of covalent bond, electrostatic interaction, van-der-Waals bond, dipole-dipole interactions, hydrogen bond, coordinative bond, London forces or any combination thereof. The terms “physisorption” and “chemisorption” are well-understood by a skilled artisan.

In some embodiments, the phosphorous specie bound by the labile bond (also referred to as labile phosphorous) comprises phosphorous specie bound to the organic material and optionally bound to the sorbent by physisorption. In some embodiments, the phosphorous specie bound by the moderately labile bond (also referred to as moderately labile phosphorous) comprises phosphorous specie bound to the iron-based compound (iron oxide/hydroxide). In some embodiments, the phosphorous specie bound by the strong bond (also referred to as stable phosphorous) comprises phosphorous specie bound to the calcium-based compound (calcium oxide/hydroxide, calcium carbonate or both). In some embodiments, the phosphorous specie bound by the strong bond and/or by the moderately labile bond is bound to the sorbent by chemisorption.

In some embodiments, binding of the phosphorous specie to the sorbent is reversible. In some embodiments, the composition is capable of releasing the phosphorous specie bound thereto. In some embodiments, the composition or the sorbent is capable of repetitively binding and releasing the phosphorous specie. In some embodiments, the sorbent is capable of repetitively adsorbing and desorbing the phosphorous specie. In some embodiments, release is by desorption of the phosphorous specie from the sorbent. In some embodiments, release is by at least partial dissolution of the phosphorous specie. In some embodiments, release is by at least partial dissolution of the sorbent. In some embodiments, release is by at least partial degradation and/or erosion of the sorbent. In some embodiments, release is upon contact of the composition with soil and/or area under cultivation. In some embodiments, release is induced by one or more triggers as described hereinbelow.

In some embodiments, the composition of the invention is capable of releasing the phosphorous specie bound thereto, wherein releasing is induced and/or enhanced by a biodegradation of the composition. In some embodiments, the phosphorous specie is released from the composition of the invention upon contacting the composition with a soil. In some embodiments, the soil is a non-sterile soil. In some embodiments, the release of the phosphorous specie is induced and/or enhanced by a soil microbiome. In some embodiments, the release of the phosphorous specie is induced and/or enhanced by a biodegradation of the composition and/or the sorbent of the invention. In some embodiments, the release of the phosphorous specie (e.g., organic phosphorus) is induced and/or enhanced by cleavage of the covalent bond between the phosphate group and the organic molecule bound thereto. In some embodiments, induced or enhanced is as described herein. In some embodiments, induced or enhanced is relative to a control, wherein the control is as described herein (e.g. a solid fertilizer, a solid fertilizer being substantially devoid of the organic matter).

Without being bound to any particular theory or mechanism, it is postulated that the reversible binding of the phosphorus specie to the sorbent is at partially related to the enrichment of the sorbent with the organic material. It is further postulated, that the organic material may contribute to a labile bond formation to the phosphorus specie, thereby enhancing or inducing reversible binding of the phosphorus specie to the sorbent. Additionally, it is postulated, that the organic material may further contribute to the increase of the organic phosphorus content of the composition, which upon degradation (e.g. hydrolysis) is converted into the phytoavailable phosphorus specie, as described herein.

In some embodiments, the sorbent of the invention comprises an inorganic material and an organic material.

In some embodiments, the inorganic material of the sorbent comprises a salt, a metal oxide, a non-metal oxide, and a combination thereof. In some embodiments, the inorganic material of the sorbent comprises an organometallic complex. In some embodiments, the organometallic complex relates to one or more complexes of a d-electron transition metal. In some embodiments, the inorganic material of the sorbent comprises a metal salt, including any derivative thereof (such as a hydrate, an inorganic complex or both). In some embodiments, the inorganic material of the sorbent of the invention is crystalline. In some embodiments, the inorganic material of the sorbent has an amorphous structure.

In some embodiments, between 10 and 90%, between 10 and 20%, between 20 and 30%, between 30 and 40%, between 40 and 50%, between 50 and 60%, between 70 and 80%, between 80 and 90%, by dry weight of the inorganic material of the sorbent of the invention is crystalline. Each range or value represents a separate embodiment of the invention.

In some embodiments, the inorganic material of the sorbent comprises between 5 and 25% of the iron specie, between 5 and 50% of the calcium specie, and optionally up to about 9% of the aluminum specie by total dry weight of the sorbent. In some embodiments, the sorbent comprises between 10 and 25% of the iron specie (e.g. iron oxide and/or iron hydroxide), between 10 and 30% of the organic material, between 20 and 50% of the calcium specie (e.g. CaO, Ca(OH)₂, and/or CaCO₃), and optionally up to 10% or up to 10% of the aluminum specie by total dry weight of the sorbent. In some embodiments, the inorganic material of the sorbent further comprises at least one of (i) between 0.1 and 5% of a magnesium specie (such as MgO and/or of magnesium hydroxide and/or magnesium salt), and (ii) between 10 and 40% of silica, by total dry weight of the sorbent.

In some embodiments, the inorganic material of the sorbent comprises between 5and 25% of iron oxide and/or iron hydroxide (Fe-II and/or Fe-III), between 5 and 50% of the calcium specie (CaO and/or CaCO₃), and optionally up to about 9% of the aluminum specie (e.g. Al₂O₃ and/or Al₂(OH)₃) by total dry weight of the sorbent. In some embodiments, the sorbent comprises between 10 and 25% of Fe₂(OH)₃, between 10 and 30% of organic material, between 20 and 50% of Ca(OH)₂, and optionally up to 10% or up to 10% of Al₂O₃ and/or Al₂(OH)₃ by total dry weight of the sorbent. In some embodiments, the inorganic material of the sorbent further comprises at least one of (i) between 0.1 and 10% of MgO and/or of magnesium hydroxide, and (ii) between 10 and 40% of silica, by total dry weight of the sorbent.

In some embodiments, the sorbent of the invention comprises between 5 and 10%, between 10 and 25%, between 10 and 15%, between 15 and 20%, between 20 and 25%, between 25 and 30%, between 30 and 40%, including any range therebetween of the iron specie by total dry weight of the sorbent.

In some embodiments, the sorbent of the invention comprises between 1 and 5%, between 5 and 10%, between 10 and 15%, between 15 and 20%, including any range therebetween of the iron specie (e.g. Fe(II) and/or Fe(III) cation) by total dry weight of the sorbent.

In some embodiments, the sorbent of the invention comprises between 5 and 10%, between 10 and 25%, between 10 and 15%, between 20 and 50%, between 20 and 25%, between 25 and 30%, between 30 and 35%, between 35 and 40%, between 40 and 45%, between 45 and 50%, including any range therebetween of the calcium specie.

In some embodiments, the inorganic material of the hereindisclosed sorbent comprises between 10 and 25% of the iron specie, between 20 and 50% of calcium specie, between 0.1 and 5% of the magnesium specie, and between 10 and 40% of silica, by total dry weight of the sorbent.

In some embodiments, the sorbent of the invention comprises between 0.1 and 5%, between 0.1 and 0.5%, between 0.5 and 1%, between 1 and 2%, between 2 and 5%, between 5 and 10%, including any range therebetween of the magnesium specie (e.g. magnesium oxide and/or magnesium hydroxide), by total dry weight of the sorbent.

In some embodiments, the sorbent of the invention comprises between 10 and 15%, between 15 and 20%, between 20 and 25%, between 25 and 28%, between 28 and 30%, between 30 and 35%, between 35 and 40%, between 40 and 45%, between 45 and 50%, including any range therebetween of silica, by total dry weight of the sorbent.

In some embodiments, the inorganic material of the sorbent of the invention consists essentially of: between 10 and 25% of the iron specie (e.g. iron oxide and/or iron hydroxide), between 20 and 50% of the calcium specie (e.g. calcium oxide and/or calcium hydroxide), between 0.1 and 10% of the magnesium specie (e.g. magnesium oxide and/or of magnesium hydroxide), and between 10 and 40% of silica by total dry weight of the sorbent.

In some embodiments, at least 80%, at least 85%, at least 90%, at least 92%, at least 95%, at least 96%, at least 97%, at least 99% including any range or value therebetween, by weight of the inorganic material consists of: between 10 and 25% of the iron specie (e.g. iron oxide and/or iron hydroxide), between 20 and 50% of the calcium specie (e.g. calcium oxide and/or calcium hydroxide), between 0.1 and 5% of the magnesium specie (e.g. magnesium oxide and/or of magnesium hydroxide), and between 10 and 40% of silica by total dry weight of the sorbent.

In some embodiments, the inorganic material further comprises an additional inorganic specie selected from phosphorus pentoxide, potassium oxide and/or potassium hydroxide, and sodium oxide and/or sodium hydroxide or a combination thereof. In some embodiments, the additional inorganic specie comprises a salt, such as a chloride salt (e.g. NaCl, KCl), a sulfite salt (e.g. Na₂SO₃), a nitrate salt, a phosphate salt, or any combination thereof. In some embodiments, the additional inorganic specie comprises any of a potassium salt, a sodium salt, a copper salt, or any combination thereof.

In some embodiments, the weight per weight (w/w) ratio of the additional inorganic specie within the sorbent is at most 20%, at most 17%, at most 15%, at most 10%, at most 8%, at most 6%, at most 5%, at most 1%, including any range therebetween.

In some embodiments, any of the inorganic material, the organic material of the sorbent, or both are capable of binding the phosphorus specie. In some embodiments, any one of the iron specie of the invention; the magnesium specie invention; silicon oxide, and the calcium specie of the invention are capable of binding the phosphorus specie. In some embodiments, any one of iron oxide and/or iron hydroxide; magnesium oxide and/or of magnesium hydroxide; silicon oxide, and calcium oxide and/or calcium hydroxide within the sorbent, is capable of adsorbing and/or desorbing the phosphorus specie.

As used herein the term “phosphorus specie” is referred to a phytoavailable phosphorous specie, wherein phytoavailable is as described herein. In some embodiments, a content of the phytoavailable phosphorus specie is determined according to the Olsen phosphorus test. One skilled in the art will appreciate that the Olsen phosphorus test is only a non-limiting example of various analytical methods, which can be utilized for the determination of the phytoavailable phosphorus content. In some embodiments, the phosphorous specie (e.g. phytoavailable phosphorus specie) comprises phosphorus species bound to the sorbent via a moderately labile bond and/or via a labile bond as described herein. In some embodiments, the phosphorous specie of the invention is released into a soil or area under cultivation upon contacting the composition of the invention therewith. In some embodiments, the release of the phosphorous specie from the sorbent is induced by a trigger, such as by soil microbiome. In some embodiments, the phosphorous specie becomes phytoavailable upon contact of the composition of the invention with soil. In some embodiments, the phytoavailability of the phosphorus specie (e.g. organic phosphorus species, various inorganic phosphorus salts, or any other phosphorus species) is at least partially enhanced and/or induced by a trigger, such as by soil microbiome, soil pH, water, or a combination thereof.

In some embodiments, the sorbent comprises between 10 and 20% of iron cation, between 10 and 30% of calcium cation, between 0.1 and 10% of magnesium cation, and between 20 and 40% of silica by total dry weight of the sorbent.

In some embodiments, the sorbent comprises between 10 and 20%, between 10 and 12%, between 12 and 15%, between 15 and 20%, including any range therebetween of iron by total dry weight of the sorbent, wherein iron is referred to the iron specie of the invention comprising iron in an elemental state and/or iron in an oxidized form (e.g. iron (II) or iron (III) cation).

In some embodiments, the sorbent comprises between 10 and 15%, between 15 and 18%, between 18 and 20%, between 20 and 25%, between 25 and 30%, including any range therebetween of calcium by total dry weight of the sorbent, wherein calcium is referred to the calcium specie of the invention comprising calcium in an elemental state and/or calcium in an oxidized form (e.g. calcium (II) cation).

In some embodiments, the w/w content of the inorganic material within the sorbent is between 60 and 95%, between 60 and 65%, between 65 and 70%, between 70 and 75%, between 75 and 80%, between 80 and 85%, between 85 and 90%, between 90 and 75%, by total dry weight of the sorbent.

In some embodiments, the sorbent comprises additional inorganic materials (e.g. metal salts and/or metal oxide) which are well-known in the art.

In some embodiments, the sorbent of the invention comprises between 5 and 15%, between 10 and 15%, between 15 and 20%, between 20 and 25%, between 25 and 30%, between 30 and 40%, between 40 and 45%, between 45 and 50%, including any range therebetween of the organic material.

In some embodiments, the sorbent of the invention comprises between 10 and 15%, between 15 and 18%, between 18 and 20%, between 20 and 25%, between 25 and 30%, including any range therebetween of calcium by total dry weight of the sorbent, wherein calcium is referred to the calcium specie of the invention comprising calcium in an elemental state and/or calcium in an oxidized form (e.g. calcium (II) cation).

In some embodiments, the organic material comprises humic substances and additional organic compounds. Humic substances are well-known in the art being an important part of important components of humus, the major organic fraction of soil, peat, and coal. Additionally, humic substances are found in the surface water (e.g. sea water, and/or in some embodiments, the organic material comprises humic acid. In some embodiments, the organic material content of the composition is determined by calculating the mass loss of the composition on ignition. In some embodiments, the organic material comprises a thiol-based compound. In some embodiments, the organic material comprises an organic phosphorus specie (e.g. phosphorylated proteins, phospholipids, or other phosphorylated organic compounds).

In some embodiments, the organic material is capable of binding the phosphorus specie. In some embodiments, the organic material is capable of adsorbing and/or desorbing the phosphorus specie.

In some embodiments, the sorbent of the invention comprises between 5 and 25% of the iron specie, between 5 and 50% of the calcium specie, between 5 and 40% of the organic material, between 0.1 and 10% of the magnesium specie, between 10 and 40% of silica, and optionally up to about 9% of the aluminum specie by total dry weight of the sorbent. In some embodiments, the sorbent of the invention comprises between 10 and 25% of the iron specie (e.g. iron salt, iron oxyhydroxide, iron oxide and/or iron hydroxide), between 10 and 40% of the organic material, between 20 and 50% of the calcium specie (e.g. CaO, Ca(OH)₂, and/or CaCO₃), between 15 and 40% of silica, optionally between 1 and 10% of the magnesium specie, and optionally up to 10% or up to 9% of the aluminum specie by total dry weight of the sorbent. In some embodiments, the inorganic material of the sorbent further comprises at least one of (i) between 0.1 and 10% of a magnesium specie (such as MgO and/or of magnesium hydroxide and/or magnesium salt), and (ii) between 10 and 40% of silica, by total dry weight of the sorbent.

In some embodiments, a w/w content of the phosphorous specie (e.g. phytoavailable phosphorous specie, as described herein) within the sorbent (e.g. non-enriched sorbent) is at most 10 mg/kg, at most 20 mg/kg, at most 30 mg/kg, at most 40 mg/kg, by dry weight of the sorbent including any range therebetween.

In some embodiments, a w/w content of the iron specie (e.g. phytoavailable iron specie, as described herein) within the sorbent is at most 50 mg/kg, at most 100 mg/kg, at most 130 mg/kg, by dry weight of the sorbent including any range therebetween.

In some embodiments, the sorbent comprises at least 50%, at least 60%, at least 70%, at least 80%, at least 90%, at least 95%, at least 97%, at least 99% water treatment residuals (WTR) by dry weight of the sorbent. In some embodiments, the sorbent is WTR. In some embodiments, the WTR is selected from drinking water treatment residuals, seawater treatment residuals or both. In some embodiments, the sorbent comprises seawater WTR. In some embodiments, the composition comprises at least 50%, at least 60%, at least 70%, at least 80%, at least 90%, at least 95%, at least 97%, at least 99% WTR by dry weight of the composition.

In some embodiments, the composition and/or the sorbent is substantially devoid of an additional inorganic material. In some embodiments, the composition and/or the sorbent is substantially devoid of an additional organic material. In some embodiments, the composition and/or the sorbent is substantially devoid of an additional material capable of binding the phosphorus specie. In some embodiments, the composition and/or the sorbent is substantially devoid of a chelator, a phase-transfer catalyst, etc. In some embodiments, the composition and/or the sorbent is substantially devoid of an additional source of the phosphorus specie. In some embodiments, the composition and/or the sorbent is substantially devoid of nano-particles, nano-wires, and/or nano-tubes.

As used herein the term “WTR” refers to by-products of the coagulation and flocculation phase of the water (e.g. drinking water, a river, a lake, a reservoir, a pond, a stream, groundwater, spring water, surface water, and/or seawater or combinations thereof) treatment process that is employed in the vast majority of water treatment plants. As used herein the term “WTR” refers to iron-based WTR, formed by addition of Fe salts (e.g. FeCl₃) to the drinking water and/or seawater. In some embodiments, WTR is substantially devoid of alum (e.g. aluminum oxide)-based WTR.

Without being bound to any particular theory or mechanism, WTR is formed by adding Fe salts to the raw drinking water or sea water in a settling or filtration pretreatment stage. It is postulated that when Fe salts are applied as coagulants (at slightly acid, neutral and/or alkaline pH) their Fe ions are hydrolyzed to form hydroxide precipitates that remove impurities via co-precipitation, sorption, flocculation and settling. Iron-based coagulants are used as filtration aid (either media filters or UF/MF membranes) and collected in the filter's backwash waste.

It is postulated that the process involves formation of positively charged complexes that are able to sorb and flocculate negatively charged organic impurities effectively by overcoming their initial repelling characteristics. Depending on the design of a particular water treatment plant, removal of the impurities then proceeds via simple flocculation and settlement under gravity or via a more active process of filtration. In some embodiments, the sorbent (e.g. WTR) comprises the inorganic material and/or the organic material, as described hereinabove. In some embodiments, the sorbent (e.g. WTR) comprises inorganic particles, such as clay particles. In some embodiments, the sorbent (e.g. WTR) comprises up to 5% by weight of micronutrients, such as nitrogen species (e.g. nitrogen oxides, nitrate salt), potassium species, metal cations (e.g. Zn, Cu, Mn cations) or a combination thereof. One skilled in the art will appreciate, that the exact chemical composition and the exact concentration of any one of the components the WTR may be variable, depending on the water source, and location of the water treatment plant.

In some embodiments, an exemplary composition of the sorbent (e.g. WTR) is as exemplified in the Examples section.

In some embodiments, the composition of the invention comprises the WTR enriched with the phosphorous specie. In some embodiments, the composition of the invention comprises the WTR enriched with the organic material. In some embodiments, the composition of the invention comprises the WTR enriched with the organic material and with the phosphorous specie. In some embodiments, the composition of the invention comprises the WTR bound to the organic material and to the phosphorous specie.

In some embodiments, the composition of the invention comprises the WTR enriched with the organic material (OM) and with the phosphorous specie, wherein the weight content of the OM within the composition of the invention is at least 15%, at least 20%, at least 25%, at least 28%, at least 30%, including any range therebetween.

In some embodiments, the composition of the invention comprises a composite, comprising the WTR bound to the organic material and to the phosphorous specie. In some embodiments, the composite is stable. In some embodiments, the composition of the invention is a composite comprising the inorganic material and the organic material, wherein the inorganic material and the organic material are as described herein. In some embodiments, the inorganic material and the organic material are substantially homogenously distributed within the composition of the invention (e.g. composite). In some embodiments, the inorganic material and the organic material are substantially non-homogenously distributed within the sorbent of the invention (e.g. in a form of layers).

In some embodiments, the inorganic material and the organic material are bound via a non-covalent bond, as described herein. In some embodiments, the organic material is adsorbed to the inorganic material, wherein adsorbed is as described herein. In some embodiments, the organic material is embedded on or within the inorganic material. In some embodiments, the inorganic material is in a form of a matrix, comprising the organic material bound thereto. In some embodiments, the inorganic material and the organic material are stably bound to each other, thereby resulting in the sorbent in a form of a composite.

In some embodiments, the composition is stable at a temperature of less than 200° C., less than 150° C., less than 100° C., less than 80° C., less than 50° C., including any range or value therebetween. In some embodiments, the composition is stable at a temperature of at most 300° C., at most 200° C., at most 150° C., at most 100° C., at most 80° C. including any range or value therebetween. As used herein the term “stable” refers to the capability of the composition to maintain its structural and/or chemical integrity. In some embodiments, the composition is referred to as stable, if the composition is substantially devoid of decomposition and/or dissociation wherein substantially is as described herein. In some embodiments, the composition is referred to as stable, if the composition substantially maintains its phosphorus content wherein substantially is as described herein. In some embodiments, the composition is referred to as stable, if the composition substantially maintains a content of one or more inorganic species (such as nitrogen-based species, iron-based species, potassium-based species etc.) wherein substantially is as described herein. In some embodiments, the composition is referred to as stable, if the composition substantially maintains a content of organic material, wherein substantially is as described herein. In some embodiments, the stable composition is configured to substantially retain the adsorbed phosphorous specie, wherein substantially is as described herein. In some embodiments, the stable composition substantially maintains its structural and/or chemical integrity under storage conditions. In some embodiments, the stable composition substantially maintains its structural and/or chemical integrity upon contact with soil and/or area under cultivation.

The storage conditions may comprise parameters such as temperature of between 0 and 100° C., UV and/or visible light irradiation, and exposure to moisture. In some embodiments, the stable composition is rigid under storage conditions. In some embodiments, the stable composition is chemically inert under storage conditions.

In some embodiments, the composition of the invention is stable for a time period ranging between 1 week (w) and 10 years (y), between 1 and 4 w, between 1 and 3 moths (m), between 3 and 5 m, between 5 and 7 m, between 7 and 9 m, between 9 and 12 m, between 1 and 2 y, between 2 and 5 y, between 5 and 7 y, between 7 and 10 y, including any range therebetween.

In some embodiments, the composition of the invention comprises the WTR enriched with or bound to an organic material. In some embodiments, the composition of the invention comprises the WTR enriched with the organic material and with the phosphorus specie of the invention.

In some embodiments, the organic material is an organic residual material. In some embodiments, the organic residual material comprises an organic material present in the wastewater, wherein the wastewater is as described herein. In some embodiments, the organic material originates or is extracted from a wastewater. In some embodiments, the organic material is from a wastewater source.

In some embodiments, the composition of the invention comprises the sorbent as described herein enriched with the phosphorus specie of the invention and with the organic material, wherein at least 20%, at least 30%, at least 40%, at least 50%, at least 60%, at least 70%, at least 80% by weight of the organic material including any range therebetween originates or is extracted from a wastewater.

In some embodiments, between 20 and 90%, between 20 and 30%, between 30 and 50%, between 50 and 70%, between 70 and 90%, including any range therebetween by weight of the organic material within the composition of the invention originates or is derived from a wastewater.

In some embodiments, the composition of the invention comprises the WTR enriched with or bound to a wastewater residual material (e.g. wastewater residual organic material). In some embodiments, the composition of the invention comprises the WTR enriched with or bound to dairy wastewater residual material.

In some embodiments, the wastewater comprises enhanced concentration (e.g. greater than 0.5 mg/l, usually of about 5 to 20 mg/l) of one or more organic and/or inorganic phosphorus species. In some embodiments, the wastewater comprises animal wastewater and manure. In some embodiments, the wastewater is or comprises industrial wastewater and/or municipal wastewater. In some embodiments, the wastewater comprises inter alia a phosphorus specie. In some embodiments, the wastewater comprises agricultural wastewater. In some embodiments, the wastewater comprises farming industry wastewater and/or livestock wastewater. In some embodiments, the wastewater and/or the organic material derived therefrom originates from dairy industry, olive oil mill, wineries, piggeries, cowsheds, slaughterhouses, fruit and vegetable processing industry, or soy or coffee bean industry or a combination thereof. In some embodiments, the wastewater and/or the organic material derived therefrom is a recreational water from a coastal beach, lake, river, or pond. In some embodiments, the wastewater comprises dairy wastewater. In some embodiments, the wastewater comprises livestock wastewater (e.g. sourcing from cowshed, dairy, piggeries etc.) and manure. In some embodiments, the wastewater and/or the organic material derived therefrom comprises at least partially pretreated wastewater. Pretreated wastewater may refer to a wastewater treated by any one of the water-treatment processes, which are well-known in the art (e.g. sedimentation, aerobic biological treatment, disinfection etc.).

In some embodiments, the composition is in from of a particulate matter. In some embodiments, the sorbent is in from of a particulate matter. In some embodiments, the particulate matter comprises particles with an average particle size between 10 μm and 1000 μm. In some embodiments, the average particle size between 10 μm and 20 μm, between 10 μm and 12 μm, between 12 μm and 15 μm, between 15 μm and 17 μm, between 17 μm and 20 μm, between 20 μm and 30 μm, between 30 μm and 40 μm, between 40 μm and 50 μm, between 50 μm and 100 μm, between 100 μm and 200 μm, between 200 μm and 300 μm, between 300 μm and 400 μm, between 400 μm and 500 μm, between 500 μm and 700 μm, between 700 μm and 1000 μm, including any range or value therebetween. In some embodiments, the average particle size refers to an average size of dry particles.

In some embodiments, the particle comprises a core and a shell. In some embodiments, the particle is a core-shell part wherein the core comprises the inorganic material and the shell at least partially comprises the organic material. In some embodiments, any one of the core or the shell of the particle is capable of absorbing the phosphorous specie.

In some embodiments, the particle has a surface area of between 100 and 2000 m²/g, between 100 and 500 m²/g, between 500 and 600 m²/g, between 600 and 700 m²/g, between 700 and 800 m²/g, between 800 and 900 m²/g, between 900 and 1000 m²/g, between 1000 and 1200 m²/g, between 1200 and 1500 m²/g, between 1500 and 1700 m²/g, between 1700 and 2000 m²/g, including any range between. In some embodiments, the particle has a surface area of between 900 and 1000 m²/g.

In some embodiments, the composition comprises the sorbent enriched with the phosphorus specie of the invention, wherein a w/w ratio of the phosphorus specie to the sorbent within the composition is between 0.01 and 10%, between 0.01 and 0.1%, between 0.1 and 0.5%, between 0.5 and 1%, between 1 and 2%, between 2 and 3%, between 3 and 5%, between 5 and 7%, between 7 and 10%, including any range or value therebetween by dry weight of the composition.

In some embodiments, the composition comprises a plurality of particles, wherein the particles are as described herein. In some embodiments, the composition comprises the phosphorus specie bound to the plurality of particles. In some embodiments, the phosphorus specie bound is bound to the core and/or to the shell of the plurality of particles, wherein bound is as described hereinabove.

In some embodiments, the composition comprises the sorbent enriched with the phosphorus specie, wherein at least 60%, at least 70%, at least 80%, at least 90%, at least 92%, at least 95%, at least 97%, at least 99% by weight of the phosphorus specie is bound to any of (i) the organic material, (ii) the iron specie of the invention, (iii) the magnesium specie of the invention (e.g. magnesium oxide and/or magnesium hydroxide, and/or a salt thereof), (iv) silica, or to (v) the calcium specie of the invention (e.g. oxide and/or calcium hydroxide, or to a combination thereof, and wherein bound is as described herein.

In some embodiments, the composition comprises the sorbent enriched with the phosphorus specie and with the organic material. In some embodiments, the composition comprises the sorbent enriched with the phosphorus specie and with the organic material, wherein the enrichment of the composition with the organic material is between 5 and 20%, between 5 and 10%, between 10 and 15%, between 15 and 20% by weight of the composition including any range between, compared to the non-enriched composition (e.g. pristine WTR). In some embodiments, enrichment of the sorbent with the organic material is between 5 and 100%, between 5 and 10%, between 10 and 15%, between 15 and 20%, between 20 and 50%, between 50 and 70%, between 70 and 100% by weight including any range between, compared to the weight content of the organic material in the non-enriched sorbent.

In some embodiments, the composition comprises the sorbent enriched with the phosphorus specie of the invention, wherein enrichment is between 10 and 1000%, between 10 and 50%, between 50 and 100%, between 100 and 200%, between 200 and 300%, between 300 and 400%, between 400 and 600%, between 600 and 1000%, greater w/w ratio of the phosphorus specie to the sorbent including any range or value therebetween, compared to the non-enriched sorbent (e.g. pristine WTR).

In some embodiments, the w/w content of the organic material within the composition is between 10 and 40%, between 10 and 15%, between 15 and 20%, between 20 and 25%, between 25 and 30%, between 30 and 32%, between 32 and 35%, between 35 and 40%, between 40 and 50% including any range or value therebetween by dry weight of the composition.

In some embodiments, the w/w content of the iron specie of the invention within the composition is between 5 and 40%, between 5 and 8%, between 8 and 10%, between 10 and 12%, between 12 and 15%, between 15 and 20%, between 20 and 25%, between 25 and 30%, between 30 and 35%, between 35 and 40%, including any range or value therebetween by dry weight of the composition.

In some embodiments, the w/w content of the magnesium specie of the invention within the composition is between 1 and 15%, between 1 and 5%, between 5 and 7%, between 7 and 9%, between 9 and 12%, between 12 and 15%, including any range or value therebetween by dry weight of the composition.

In some embodiments, the w/w content of the calcium specie of the invention within the composition is between 2 and 50%, between 2 and 5%, between 5 and 7%, between 7 and 8%, between 8 and 9%, between 9 and 12%, between 12 and 15%, between 15 and 20%, between 20 and 25%, between 25 and 30%, between 30 and 35%, between 35 and 40%, between 40 and 50%, including any range or value therebetween by dry weight of the composition.

In some embodiments, the w/w content of silica within the composition is between 20 and 35%, between 20 and 25, between 25 and 30%, between 27 and 29, between 30 and 32%, between 32 and 35%, between 35 and 40%, between 40 and 45%, including any range or value therebetween by dry weight of the composition.

In some embodiments, the w/w content of the aluminum specie (e.g. aluminum oxide and/or hydroxide) within the composition of the invention is between 2 and 15%, between 2 and 5%, between 5 and 7%, between 7 and 8%, between 8 and 9%, between 9 and 12%, between 12 and 15%, including any range or value therebetween by dry weight of the composition.

In some embodiments, the composition of the invention further comprises additional inorganic material, wherein the w/w content of the additional inorganic material with the composition is between 2 and 15%, between 2 and 5%, between 5 and 10%, between 10 and 15%, including any range or value therebetween by dry weight of the composition, and wherein the additional inorganic material is as described herein.

In some embodiments, an exemplary composition (e.g. comprising the enriched sorbent) is as exemplified in the Examples section. In some embodiments, the chemical composition (i.e. inorganic and/or organic species) of the sorbent and/or the composition of the invention is determined by X-ray fluorescence (XRF). Detailed XRF conditions are provided in the Examples section.

In some embodiments, the phosphorus specie is a phytoavailable phosphorus specie. In some embodiments, at least 5%, at least 10%, at least 15%, at least 20%, at least 30%, at least 40%, at least 50%, at least 60%, at least 70%, at least 80%, at least 90%, at least 95%, at least 97%, at least 99% by weight of the phosphorus specie including any range or value therebetween, is phytoavailable.

As used herein the term “phytoavailable” refers to availability of phosphorus species for plant uptake and/or accumulation, wherein the uptake and/or accumulation is by the plant, and/or a part of the plant (such as roots, leaves, stem, fruits, seeds, etc.). In some embodiments, a phytoavailable phosphorus specie and/or iron specie refers to water-soluble phosphorus and/or iron species (e.g. a phosphorus salt and/or an iron salt having water solubility of at least 0.1 g/L, at least 1 g/L, at least 10 g/L, at least 20 g/L, at least 30 g/L, at least 50 g/L, at least 100 g/L, at least 150 g/L, at least 200 g/L including any range or value therebetween).

In some embodiments, a content of the phytoavailable phosphorus specie is determined according to the Olsen phosphorus test. In some embodiments, the phytoavailable phosphorus specie comprises a phosphorus specie which can be modified (e.g. via a chemical and/or a biological reaction), so as to result in a phytoavailable phosphorus specie. In some embodiments, the phosphorus specie (e.g. organic phosphorus) is modified by a trigger (e.g. soil microbiome), wherein modified comprises inter alia a cleavage of a covalent bond (e.g. between the phosphate group and a backbone of the molecule). In some embodiments, the phosphorus specie relates to a non-phytoavailable specie, which upon contacting with the trigger (e.g. soil microbiome) becomes phytoavailable (e.g. via hydrolysis, or via degradation of a cluster).

In some embodiments, the composition of the invention is at least partially biodegradable. In some embodiments, the sorbent of the invention is at least partially biodegradable, so as to release at least a part of the phosphorus specie therefrom.

Without being limited to any theory or mechanism, it is postulated that non-phytoavailable phosphorus species, such as organic phosphorus or any other water-insoluble phosphorus derivatives (such as water insoluble phosphorus-based compounds, phosphorus minerals, etc.), can be transformed into a phytoavailable phosphorus specie (e.g. phosphate ion) by contacting thereof with soil and/or soil microbiome. In some embodiments, the sorbent is at least partially degradable and/or erodible (e.g. by water, heat, acid or basic pH, redox reaction with the soil environment, an enzyme, and/or by soil microbiome including any combination thereof). In some embodiments, the sorbent is at least partially degradable and/or erodible, so as to release at least a part of the phosphorus specie into the soil or area under cultivation.

In some embodiments, the iron specie as used herein, is a phytoavailable iron specie. In some embodiments, a content of the phytoavailable iron specie is determined according to the DTPA iron test. Olsen P-test and DTPA Fe-test are well-known in the art.

In some embodiments, at least 90%, at least 92%, at least 95%, at least 97% w/w of the phosphorus specie is stably bound to the sorbent. In some embodiments, stably bound comprises phosphorus specie which remains adsorbed to the sorbent upon extraction with water. In some embodiments, stably bound comprises phosphorus specie which remains adsorbed to the sorbent upon prolonged storage.

In some embodiments, the composition of the invention comprises the sorbent of the invention enriched with the phosphorus specie and optionally with the organic material, wherein at least 90%, at least 92%, at least 95%, at least 97% w/w of the phosphorus specie is stably bound to the sorbent, and wherein the phosphorus specie is in a form of phosphate ion, phosphorus precipitate, phosphorus oxide, phosphate cluster, phosphorus mineral or elemental phosphorus or any combination thereof.

In some embodiments, the total phosphate content of the composition of the invention is between 1 and 10%, between 1 and 3%, between 3 and 5%, between 5 and 7%, between 7 and 10%, by weight of the composition including any range between.

In some embodiments, the total content of the phosphorus specie within the composition of the invention is at most 10%, at most 9%, at most 8%, at most 7%, at most 6%, at most 5% by weight of the composition. In some embodiments, the total content of the phosphorus specie as described herein, is sufficient for increasing or maintaining phosphate concentration within the soil, wherein the phosphate concentration is sufficient for cultivation of a plant (e.g. above 30 mg/kg, as determined by Olsen test).

The present invention in some embodiments thereof, is based on a surprising finding that applying a fertilizer having a phosphorus content of about 5% w/w to the soil resulted in phosphate concentration within the soil sufficient for cultivation of a plant. Furthermore, the yield of the cultivated plant was either the same or even increased, compared to a commercially available fertilizer with the total phosphorus content of about 20% w/w. Thus, it is postulated, that the fertilizer of the invention is capable to reduce phosphate washout from the soil, thereby reducing or substantially preventing eutrophication (i.e. water such as fresh water, groundwater etc. contamination by phosphate).

In some embodiments, the phosphorus specie comprises a total extractable phosphorus (TEP), or a total dissolved phosphorus (TDP). In some embodiments, the phosphorus specie comprises TDP, being extractable according to a procedure described herein (Examples section). The terms “TEP” and “TDP” are well-known in the art.

In some embodiments, the total phosphate content (TEP) of the composition of the invention comprises (i) between 25 and 35%, between 25 and 28%, between 28 and 30%, between 30 and 35% of labile phosphorus, (ii) between 50 and 70%, between 50 and 55%, between 55 and 60%, between 60 and 65%, between 65 and 70% of moderately labile phosphorus, and optionally (iii) between 1 and 10%, between 1 and 3%, between 3 and 5%, between 5 and 7%, between 7 and 10%, of stable phosphorus including any range between, by total weight of the phosphorus specie.

In some embodiments, the composition comprises between 1 and 30%, between 1 and 5%, between 5 and 10%, between 10 and 15%, between 15 and 20%, between 20 and 30%, including any range therebetween by weight of the phytoavailable phosphorus specie, relative to the total phosphorus content of the composition.

Without being bound to any particular theory or mechanism, it is postulated that the labile phosphorus is released form the composition during a short time period, contributing to an immediate phytoavailability of the phosphorus specie within the soil. It is further postulated that the moderately labile phosphorus, and the stable phosphorus are released for a greater time period compared to the labile phosphorus, thus contributing to delayed release of the phosphorus specie into the soil. It is postulated that the composition of the invention is characterized by a slow-release profile of the phosphorus specie (e.g. phytoavailable phosphorus) due to a substantial portion of the moderately labile phosphorus, and the stable phosphorus therewithin. The labile phosphorus, the moderately labile phosphorus, and the stable phosphorus are as described herein. Furthermore, it is postulated that the organic phosphorus is released for a greater time period compared to the inorganic phosphorus. In some embodiments, the release of the organic phosphorus form the composition of the invention is predetermined by degradation of the covalent bond between the phosphorus specie and the organic molecule covalently bound thereto.

In some embodiments, the phosphorus specie comprises an inorganic phosphate, an organic phosphate or both. In some embodiments, the weight ratio of the organic phosphate within the phosphorus specie is between 5 and 30%, between 5 and 10%, between 10 and 15%, between 15 and 20%, between 20 and 25%, between 25 and 30%, including any range therebetween (see for example Table 3).

In some embodiments, the weight ratio of the inorganic phosphate within the phosphorus specie is between 70 and 95%, between 90 and 95%, between 85 and 90%, between 80 and 85%, between 70 and 75%, between 75 and 80%, between 95 and 97%, including any range therebetween.

In some embodiments, inorganic phosphate is selected from the group consisting of: a phosphate, a diphosphate, a triphosphate, polyphosphate, hexametaphosphate and trimetaphosphate, including any combination or a salt thereof. In some embodiments, the phosphorus specie is substantially devoid of phosphorus pentoxide, wherein substantially is as described herein.

In some embodiments, the inorganic phosphate comprises inorganic phosphorus precipitates and/or phosphorus minerals (such as apatite, fluorapatite, phosphophyllite, turquoise and vivianite).

In some embodiments, the organic phosphate is selected from the group consisting of: a phosphate monoester, a phosphodiester, a thiophosphate, a phosphothioether, and a phosphotriester (e.g. ATP), including any combination or a salt thereof. In some embodiments, the organic phosphate is bound to an organic molecule such as a saccharide, a fatty acid, a lipid, an amino acid, DNA, a peptide, a protein, a humic specie, an organic acid, including any combination thereof.

In some embodiments, a water content of the composition is between 0.01 and 10%, between 0.01 and 0.1%, between 0.1 and 1%, between 1 and 3%, between 3 and 5%, between 5 and 10%, between 10 and 20%, between 20 and 30%, between 30 and 40% by weight including any range therebetween.

In some embodiments, the composition of the invention comprises the sorbent enriched with the phosphorus specie, wherein enriched is by at least 50%, at least 100%, at least 500%, at least 1000%, at least 10000%, at least 100.000%, at least 1.000.000% compared to the pristine (e.g. non-enriched) sorbent. In some embodiments, the w/w concentration of the phosphorus specie within the enriched sorbent is at least 10 times, at least 100 times, at least 500 times, at least 1000 times greater compared to the pristine (e.g. non-enriched) sorbent.

In some embodiments, the composition of the invention is configured to release the phosphorous specie bound thereto. In some embodiments, the composition of the invention is configured to release at least 50%, at least 60%, at least 70%, at least 80%, at least 90%, at least 93%, at least 95%, at least 97%, at least 99% by weight of the phosphorus specie including any range between, wherein phosphorus specie refers to the initial amount of the phosphorus specie within the composition.

In some embodiments, the composition of the invention is characterized by a gradual release profile of the phosphorous specie (e.g. into the soil). In some embodiments, release (or desorption) comprises dissociation of the phosphorous specie from the sorbent. In some embodiments, release (or desorption) of the phosphorus specie is induced by a trigger. In some embodiments, the trigger comprises any one of electron donating specie (a reducing agent), pH (e.g. between 5 and 10), a metal chelator, and irrigation or any combination thereof. In some embodiments, the trigger is by contacting the composition of the invention with a growing plant, soil and/or area under cultivation. In some embodiments, the trigger comprises a soil microbiome. In some embodiments, the trigger comprises degradation and/or erosion.

In some embodiments, the soil microbiome refers to microorganisms living in a particular environment, including in the soil surrounding and/or interacting with the root of a plant. In some embodiments, the soil microbiome refers to microorganisms located in the rhizosphere. In some embodiments, the microorganism comprises bacteria, archaea, fungi, or a combination thereof.

In some embodiments, the phosphorus specie is releasable from the composition of the invention. In some embodiments, the composition of the invention is capable of releasing (e.g. by desorption) the phosphorous specie upon contact with soil or with area under cultivation. In some embodiments, at least partial desorption of the phosphorous specie is induced by the trigger, such as a growing plant, soil, a soil microbiome, area under cultivation, or a combination thereof.

### Fertilizer

In another aspect of the invention, there is an agricultural composition comprising the composition of the invention and optionally an agriculturally acceptable carrier. In some embodiments, the agricultural composition is for enrichment of the soil with the phosphorus and/or iron specie. In some embodiments, the agricultural composition is for enhancing a concentration of the phytoavailable phosphorus and/or iron specie within the soil. In some embodiments, the agricultural composition is for enhancing a concentration of the phytoavailable phosphorus and/or iron specie within a plant. In some embodiments, the agricultural composition is for enhancing a phosphorus and/or iron content of the soil. In some embodiments, the agricultural composition is for enhancing phosphorus and/or iron content of the growing plant. In some embodiments, the agricultural composition is for enhancing phosphorus and/or iron content of the cultivated plant.

In some embodiments, the agricultural composition of the invention is for use as a fertilizer, wherein the fertilizer is as described herein. In some embodiments, there is a kit comprising the composition of the invention. In some embodiments, the kit comprises a combination of the sorbent of the invention (e.g. WTR) and a source of water contaminated with a phosphorus specie. In some embodiments, the kit comprises a combination of the composition of the invention and an active agent selected from a fertilizer, a pesticide, a carrier, or any combination thereof. In some embodiments, the kit comprises an agriculturally effective amount of the phosphorus specie.

In some embodiments, the agricultural composition is a fertilizer. In some embodiments, the fertilizer comprises the composition of the invention. In some embodiments, the fertilizer comprises an agriculturally effective amount of the composition of the invention. In some embodiments, the fertilizer of the invention comprises the enriched sorbent of the invention. In some embodiments, the fertilizer comprises an agriculturally effective amount of the enriched sorbent of the invention. In some embodiments, the fertilizer comprises an effective amount of the composition of the invention. In some embodiments, the effective amount is fertilizing effective amount. In some embodiments, the terms “fertilizer” and “enriched sorbent” are used herein interchangeably. In some embodiments, the effective amount (e.g. fertilizing effective amount) of the fertilizer of the invention is as described hereinbelow (Method section).

In some embodiments, the composition of the invention (e.g. the fertilizer) comprises agriculturally effective amount of the phosphorus specie of the invention. In some embodiments, the agriculturally effective amount is so as provide a sufficient amount of the active substance to the soil, plant and/or area under cultivation, wherein sufficient amount comprises a predefined w/w concentration of the active substance, as described herein.

In some embodiments, the fertilizer is in a form of a solid composition. In some embodiments, the fertilizer is in a form of particles, granules, pellets, or any combination thereof. In some embodiments, the fertilizer is in a form of a slurry, a sludge, a semi-solid or a semi-liquid. In some embodiments, the fertilizer comprises a nitrogen-based fertilizer, a potassium-based fertilizer, a phosphorus-based fertilizer, or any combination thereof.

In some embodiments, the fertilizer comprises the phosphorus specie, as described herein. In some embodiments, the fertilizer is a phosphorus fertilizer. In some embodiments, the fertilizer comprises the phosphorus specie, and at least one of N and K, including any salt or a derivative thereof, as the active substance (e.g. active fertilizing substance). In some embodiments, the fertilizer comprises the active substance comprising an ion selected from P, N, and K ions including any combination thereof. In some embodiments, the fertilizer comprises P, N and K ions at a predetermined w/w ratio, as the active fertilizing substance. In some embodiments, the predetermined ratio is adjusted for cultivation of a plant. One skilled in the art will appreciate, that the exact ratio may vary depending on the specific plant. The exact ratio may be predefined by the nutrients (e.g. N, P, K ions and/or a micro element) demand of a specific cultivated plant species, wherein the nutrients demand is so as to result in an optimal fruit yield.

In some embodiments, the salt of any one of P, N, and K is an agriculturally acceptable salt.

In some embodiments, the fertilizer further comprising Fe specie as the active substance. In some embodiments, the fertilizer further comprising a micro element as the active substance. In some embodiments, the micro element is selected from Mg, Ca, S, Fe, Mn, Zn, B, Cu, Mo, and Si, including any salt, a derivative or a combination thereof. Non-limiting examples of agriculturally acceptable salts include but are not limited to cations derived from alkali or alkaline earth metals (e.g. sodium, potassium, and magnesium), cations derived from ammonia and amines (e.g. ammonium, diethyl ammonium, ethanol ammonium, isopropyl ammonium) and trimethyl sulfonium salts. Non-limiting examples of agriculturally acceptable salts include but are not limited to anions such as halide (e.g. chloride, fluoride, and bromine), hydroxide, sulfate, sulfite, nitrate, acetate, carbonate, citrate, phosphate, or any combination thereof.

In some embodiments, the fertilizer comprises the phosphorus specie, N and K ions, and any one of Fe, Mg, Ca, S, Fe, Mn, Zn, B, Cu, Mo, and Si, including any salt, a derivative or a combination thereof as the active substance.

In some embodiments, the fertilizer comprises the active substance at a w/w concentration sufficient for controlling a predefined w/w concentration of the active substance within the soil or the area under cultivation. In some embodiments, a w/w concentration of the active substance within the fertilizer is sufficient for enhancing or maintaining a w/w concentration of the active substance within the soil or the area under cultivation, wherein enhancing or maintaining is so as to result in the predefined w/w concentration of the active substance within the soil or the area under cultivation. In some embodiments, the predefined w/w concentration of the active substance within the soil or the area under cultivation is referred to a concentration sufficient for cultivation of a plant.

Typical examples of the active substances include nitrogen fertilizer such as urea, ammonium nitrate, ammonium magnesium nitrate, ammonium chloride, ammonium sulfate, ammonium phosphate, sodium nitrate, calcium nitrate, potassium nitrate, lime nitrogen, urea-form (UF), crotonylidene diurea (CDU), isobutylidene diurea (IBDU), guanyl urea (GU); phosphate fertilizer such as calcium superphosphate, conc. superphosphate, fused phosphate, humic acid phosphorus fertilizer, calcined phosphate, calcined conc. phosphate, magnesium superphosphate, ammonium polyphosphate, potassium metaphosphate, calcium metaphosphate, magnesium phosphate, ammonium sulfate phosphate, ammonium potassium nitrate phosphate and ammonium chloride phosphate; potash fertilizer such as potassium chloride, potassium sulfate, potassium sodium sulfate, potassium sulfate magnesia, potassium bicarbonate and potassium phosphate; silicate fertilizer such as calcium silicate; magnesium fertilizer such as magnesium sulfate and magnesium chloride; calcium fertilizer such as calcium oxide, calcium hydroxide and calcium carbonate; manganese fertilizer such as manganese sulfate, manganese sulfate magnesia and manganese slag; boron fertilizer such as boric acid and borates; and iron fertilizer such as slag.

Typical examples are NPK type (N-P 205-K 20) fertilizers and they include No. 1 type such as 5-5-7 (hereinafter, the numbers mean weight percentages of N-P205-K20) and Dec. 12, 2016; No.2 type such as 5-5-5 and 14-14-14; No.3 type such as 6-6-5 and 8-8-5; No.4 type such as 4-7-9 and Jun. 8, 2011; No.5 type such as 4-7-7 and Oct. 20, 2020; No.6 type such as 4-7-4 and 6-9-6; No.7 type such as 6-4-5 and 14-10-13; No.8 type such as 6-5-5 and 18-11-11; No.9 type such as 7-6-5 and 14-12-9; No. 10 NP type such as 3-20-0 and 18-35-0; No. 11 NK type such as 16-0-12 and 18-0-16; and No.12 PK type such as 0-3-14 and 0-15-15.

Other non-limiting examples of N:P:K ratios include but are not limited to: 12:12:12 (such fertilizers are intended to meet most plant's general requirements throughout the growing season); 16:6:4 or 12:8:6 (such fertilizers containing an enhanced nitrogen concentration are intended for encouraging growth, and are often used in spring); 3:20:20 (such fertilizers containing little nitrogen and higher levels of phosphorus and potassium, are intended for stimulating root growth, stem vigor, and flower and fruit production). Other N:P:K ratios are well-known in the art, such as plant-specific fertilizers designed for use on specific plants. These feature the N-P-K ratios determined to elicit the best performance from the particular plant, as well as other elements proven valuable to that plant meant to.

Numerous predefined concentrations of the active substances (e.g. nutrients such as N, P and/or K ions) within the soil or the area under cultivation are well-known in the art. One skilled in the art will appreciate, that the exact concentration may vary depending on the cultivated plant species. The exact ratio may be predefined by the nutrients demand of a specific plant species, wherein the nutrients demand is so as to result in an optimal fruit yield.

In some embodiments, the fertilizer of the invention is capable of enhancing (i) a plant yield, (ii) a plant growth or both (i) and (ii), wherein enhancing is by at least 10% compared to a control. In some embodiments, the fertilizer of the invention comprises the effective amount of the sorbent sufficient for enhancing (i) a plant yield, (ii) a plant growth or both (i) and (ii), wherein enhancing is by at least 10% compared to a control. In some embodiments, the control is as described herein below (e.g. an untreated soil, a fertilizer having the same total phosphorus content).

In some embodiments, the fertilizer is devoid of an additional active substance. In some embodiments, the fertilizer is substantially devoid of an additive. In some embodiments, the fertilizer is substantially devoid of a coating. In some embodiments, the fertilizer is substantially devoid of an additional material such as: a filler, a composite, a clay mineral, a particulate matter, or any combination thereof. In some embodiments, the fertilizer is substantially devoid of a carrier. As used hereinthroughout, the term “substantially” is as described herein.

In some embodiments, the fertilizer further comprises between 0.1 and 90%, between 0.1 and 1%, between 1 and 3%, between 3 and 5%, between 5 and 10%, between 10 and 20%, between 20 and 30%, between 30 and 50%, between 50 and 70%, between 70 and 90%, by weight of an additive including any range or value therebetween.

In some embodiments, the additive comprises an agriculturally acceptable material. In some embodiments, the additive is selected from a filler, a surfactant, a dispersant, a binder, a coloring agent, an odorizing agent, a coating agent, or any combination thereof. Various additives are well-known in the art, including inter alia a wax-based coating, a filler such as perlite, Diatomite, Expanded clay, Shale, Pumice, Slag and Vermiculite or any combination thereof.

In some embodiments, the agricultural carrier is a soil or a plant growth medium. In some embodiments, the agricultural carrier is selected from the group consisting of: a fertilizer, a plant-based oil, and a humectant, or any combination thereof.

In some embodiments, the agricultural carrier is a solid carrier. Non-limiting examples of solid carriers include but are not limited to: mineral carriers (e.g. kaolin clay, pyrophyllite, bentonite, montmorillonite, diatomaceous earth, acid white soil, vermiculite, pearlite, loam, and silica), inorganic salts (e.g. ammonium sulfate, ammonium phosphate, ammonium nitrate, urea, ammonium chloride, and calcium carbonate), alginate, vermiculite, seed cases, other plant and animal products, or any combination thereof including a granule, a pellets, and a suspension.

In some embodiments, the agricultural carrier is a liquid carrier. In some embodiments, the agricultural carrier is an aqueous solution. In some embodiments, the agricultural carrier is an aqueous solution comprising a surfactant. Non-limiting examples of liquid carriers include but are not limited to: soybean oil and cottonseed oil, glycerol, ethylene glycol, polyethylene glycol, propylene glycol, polypropylene glycol, or any combination thereof.

In some embodiments, the agricultural carrier comprises a mixture of any one of pesta (flour and kaolin clay), agar or flour-based pellet in loam, sand, and clay.

In some embodiments, the fertilizer is in a form of a liquid (e.g. an aqueous) formulation. Non-limiting examples of formulations include but are not limited to: emulsions, wettable powders, suspensions, powders, dusts, pastes, soluble powders, granules, suspension-emulsion concentrates, natural and synthetic substances impregnated with active compound, very fine capsules in polymeric substances and in coating compositions for seed, and ULV formulations.

These formulations are produced in known manner, for example by mixing the active compounds with extenders, such as liquid solvents and/or solid carriers, optionally with the use of surface-active agents (e.g. is emulsifying agents, dispersing agents, and foam-forming agents).

In some embodiments, the additive comprises any one of: sticking agents, spreading agents, surfactants, synergists, penetrants, compatibility agents, buffers, acidifiers, defoaming agents, thickeners, and drift retardants or any combination thereof.

In some embodiments, the fertilizer comprises a tackifier or adherent.

In one embodiment, an adherent is selected from the group consisting of: alginate, a gum, a starch, a lecithin, formononetin, polyvinyl alcohol, alkali formononetinate, hesperetin, polyvinyl acetate, a cephalin, Gum Arabic, Xanthan Gum, Mineral Oil, Polyethylene Glycol (PEG), Polyvinyl pyrrolidone (PVP), Arabino-galactan, Methyl Cellulose, PEG 400, Chitosan, Polyacrylamide, Polyacrylate, Polyacrylonitrile, Glycerol, Triethylene glycol, Vinyl Acetate, Gellan Gum, Polystyrene, Polyvinyl, Carboxymethyl cellulose, Gum Ghatti, and a polyoxyethylene-polyoxybutylene block copolymer.

In some embodiments, the additive comprises a solvent. In some embodiments, water is used as a solvent. In other embodiments, organic solvents are used as auxiliary solvents. Non-limiting examples of suitable auxiliary solvents include but are not limited to: xylene, toluene or alkyl naphthalenes, chlorobenzenes, chloroethylenes, aliphatic hydrocarbons, such as cyclohexane or paraffins, mineral and vegetable oils, alcohols, such as butanol or glycol as well as their ethers and esters (e.g. ethyl lactate), ketones, such as acetone, methyl ethyl ketone, methyl isobutyl ketone or cyclohexanone, strongly polar solvents, such as dimethylformamide (DMF) and dimethyl sulfoxide (DMSO), as well as water.

Non-limiting examples of suitable emulsifying and foam-forming agents include but are not limited to: non-ionic and anionic emulsifiers, such as polyoxyethylene-fatty acid esters, polyoxyethylene-fatty alcohol ethers, for example alkylaryl polyglycol ethers, alkyl sulfonates, alkyl sulfates, aryl sulfonates as well as albumin hydrolyzation products.

Non-limiting examples of suitable dispersing agents include but are not limited to: lignin sulfite waste liquors and methylcellulose. Adhesives such as carboxymethyl cellulose and natural and synthetic polymers in the form of powders, granules, or lattices, such as gum arabic, polyvinyl alcohol and polyvinyl acetate, as well as natural phospholipids, such as cephalins and lecithins, and synthetic phospholipids, can be used for the preparation of the fertilizer of the invention. Further additives can be mineral and vegetable oils.

Non-limiting examples of surfactants include nitrogen-surfactant blends such as Prefer 28 (Cenex), Surf-N (US), Inhance (Brandt), P-28 (Wilfarm) and Patrol (Helena); esterified seed oils include Sun-It II (AmCy), MSO (UAP), Scoil (Agsco), Hasten (Wilfarm) and Mes-100 (Drexel); organo-silicone surfactants include Silwet L77 (UAP), Silikin (Terra), Dyne-Amic (Helena), Kinetic (Helena), Sylgard 309 (Wilbur-Ellis) and Century (Precision); and polysorbate-type surfactants include Polysorbate 20 (Tween20), Polysorbate 40 (Tween40), Polysorbate 60 (Tween60), and Polysorbate 80 (Tween80).

Solid fertilizers can be prepared by dispersing the composition of the invention in and on an appropriately divided solid carrier (e.g. filler), such as peat, wheat, bran, vermiculite, clay, talc, bentonite, diatomaceous earth, fuller's earth, pasteurized soil, and the like. When such formulations are used as wettable powders, biologically compatible dispersing agents such as non-ionic, anionic, amphoteric, or cationic dispersing and emulsifying agents can be used. Other non-limiting examples of solid carriers or fillers are described hereinabove.

In some embodiments, the fertilizer is for enrichment of the soil with the phosphorus specie and/or iron specie (such as Fe³⁺). In some embodiments, the fertilizer is for enhancing a concentration of the phytoavailable phosphorus and/or iron specie within the soil. In some embodiments, the fertilizer is for enhancing a concentration of the phytoavailable phosphorus and/or iron specie within a plant. In some embodiments, the fertilizer is for enhancing a phosphorus and/or iron content of the soil. In some embodiments, the fertilizer is for enhancing phosphorus and/or iron content of the growing plant. In some embodiments, the fertilizer is for enhancing phosphorus and/or iron content of the cultivated plant. In some embodiments, the fertilizer is configured for enhancing a phosphorus and/or iron content of the soil, the area under cultivation and/or the plant (.e.g. a growing plant) upon application of the fertilizer to the soil, the area under cultivation, and to the plant or any combination thereof.

In some embodiments, enhancing and/or increasing as described herein is by at least 20%, at least 50%, at least 100%, at least 200%, at least 300%, at least 400%, at least 500%, at least 1000% including any range therebetween.

In some embodiments, the fertilizer is for maintaining a concentration of the phosphorus and/or iron specie within the soil and/or area under cultivation. In some embodiments, the fertilizer is for maintaining a concentration of the phosphorus and/or iron specie at a level sufficient for cultivation of a plant. Without being limited to any theory, the concentration of the phosphorus specie within the soil appropriate for cultivation has to be at least 6 mg/kg. Without being limited to any theory, the concentration of the iron specie within the soil appropriate for cultivation has to be at least 2.5 mg/kg. In some embodiments, the iron specie is a phytoavailable iron specie, wherein phytoavailable is as described herein. In some embodiments, the phytoavailable iron specie is a water-soluble iron specie. In some embodiments, a content of the phytoavailable iron specie is determined by digestion method (see Examples).

In some embodiments, the fertilizer is capable to maintain a concentration of the phosphorus specie in the soil and/or area under cultivation within a time period ranging between 1 day and 1 week (w), between 1 week (w) and 1 year (y), between 1 and 4 w, between 1 and 3 moths (m), between 3 and 5 m, between 5 and 7 m, between 7 and 9 m, between 9 and 12 m, including any range therebetween. In some embodiments, the fertilizer is capable to maintain a concentration of the phosphorus specie in the soil sufficient for cultivation of a plant (e.g. between 6 and 100 mg/kg, preferably above 30 mg/kg Olsen-P including any range between).

In some embodiments, the fertilizer at a w/w concentration of 0.7% relative to the soil, enhances the weight concentration of the phosphorus specie within the soil by at least 1 mg/l, at least 2 mg/l, at least 3 mg/l, at least 5 mg/l, at least 7 mg/l, at least 10 mg/l including any range between, wherein the enhancement is within a time period of at least 6 days, and wherein the concentration is referred to the weight per volume concentration of the phosphorus specie within the soil.

In some embodiments, the fertilizer at a w/w concentration of 0.7% relative to the soil is capable of releasing between 200 and 1000 mg, between 200 and 300 mg, between 300 and 500 mg, between 500 and 700 mg, between 700 and 1000 mg of the phosphorus specie into the soil or the area under cultivation including any range between.

In some embodiments, the fertilizer at a w/w concentration of 0.7% relative to the soil is capable of releasing a total amount of the phosphorus specie into the soil or the area under cultivation within a time period of between 5 and 60 days, between 5 and 60 days, between 5 and 10 days, between 10 and 20 days, between 20 and 30 days, between 30 and 40 days, between 40 and 50 days, between 50 and 60 days, including any range between, wherein the total amount of the phosphorus specie is between 200 and 1000 mg including any range between.

In some embodiments, the fertilizer at a w/w ratio of between 1:100 and 1.5:100 relative to the soil, enhances the concentration of the phosphorus specie within the soil by at least 10 times, at least 20 times, at least 30 times, at least 50 times, at least 70 times, at least 100, at least 150, at least 200 times, including any range between compared to an untreated soil.

In some embodiments, the fertilizer at a w/w ratio of between 1:100 and 1.5:100 relative to the soil, enhances the w/w concentration of the phosphorus specie within the soil by at least 10%, at least 20%, at least 30%, at least 40%, at least 50%, at least 60%, at least 70%, at least 100% compared to an untreated soil, including any range between. In some embodiments, the fertilizer at a w/w ratio of 1:100 and 1.5:100 relative to the soil, enhances the w/w concentration of the phosphorus specie within the soil by at most 100%, at most 90%, at most 80%, at most 60%, at most 50%, at most 40%, at most 30%, at most 20% compared to an untreated soil, including any range between. In some embodiments, the soil is a soil before planting. In some embodiments, the soil is a soil after planting. In some embodiments, the soil is pre-harvest and/or post-harvest. In some embodiments, the soil is a planted and/or unplanted soil. In some embodiments, the soil is a sterilized soil.

In some embodiments, the fertilizer is capable to enhance the w/w concentration of the phosphorus specie within the soil by at least 10%, at least 20%, at least 30%, at least 40%, at least 50%, at least 60%, at least 70%, at least 100% including any range between compared to a control. In some embodiments, the fertilizer at a w/w ratio of between 1:100 and 1.5:100 to the soil is capable to enhance the w/w concentration of the phosphorus specie within the soil by at least 10%, at least 20%, at least 30%, at least 40%, at least 50%, at least 60%, at least 70%, at least 100% including any range between compared to a control.

In some embodiments, the control is a liquid fertilizer being devoid of phosphate. In some embodiments, the control is a liquid fertilizer comprising phosphate, wherein the fertilizer and the control are applied at a w/w ratio to the soil, so as to result in the same w/w ratio of phosphate (e.g. total phosphorus content, hereinafter “TP”) to the soil. In some embodiments, the control is a solid fertilizer comprising phosphate (such as Osmocote). In some embodiments, the control is a solid fertilizer comprising the same TP content as the fertilizer of the invention. In some embodiments, the control is a WTR enriched with inorganic phosphate. In some embodiments, the control is a WTR enriched with phosphate, wherein a weight ratio of the organic material within the control is less than 25%, less than 20%, less than 15%, less than 10%, less than 5%, less than 3%, including any range therebetween.

In some embodiments, the fertilizer at a w/w ratio of between 1:100 and 1.5:100 to the soil is capable to enhance the w/w concentration of the phytoavailable phosphorus specie within the soil up to a range of between 20 and 1000%, between 20 and 1000%, between 20 and 50%, between 50 and 100%, between 100 and 200%, between 200 and 300%, between 300 and 500%, between 500 and 1000%, between 1000 and 10000% including any range between, compared to the untreated soil, wherein the soil is a cultivated soil (such as post-planting soil and/or post-harvesting soil).

In some embodiments, the fertilizer at a w/w ratio of between 1:100 and 1.5:100 to the soil is capable to enhance the w/w concentration of the phytoavailable phosphorus specie within the soil, so as to result in a phytoavailable phosphate concentration within the soil being in a range between 60 and 100 mg/kg, between 60 and 80 mg/kg, between 80 and 90 mg/kg, between 90 and 100 mg/kg including any range between, wherein the soil is a cultivated soil (such as post-planting soil and/or post-harvesting soil).

In some embodiments, the fertilizer at a w/w ratio of between 1:100 and 1.5:100 relative to the soil, is capable to enhance the w/w concentration of the phosphorus specie within the soil by at least 10%, at least 20%, at least 30%, at least 40%, at least 50%, at least 60%, at least 70%, at least 100% including any range between, compared to a solid fertilizer comprising the same total phosphate concentration.

In some embodiments, the fertilizer at a w/w ratio of between 1:100 and 1.5:100 relative to the soil, is capable to enhance the w/w concentration of the phosphorus specie within the soil by a value ranging between 5 and 50%, between 5 and 10%, between 10 and 20%, between 20 and 25%, between 25 and 30%, between 30 and 35%, between 35 and 40%, between 40 and 50% including any range between, compared to a solid fertilizer comprising the same total phosphate concentration. In some embodiments, the fertilizer at a w/w ratio of between 1:100 and 1.5:100 relative to the soil, is capable to enhance the w/w concentration of the phosphorus specie within the soil by a value ranging between 5 and 50% including any range between, compared to a solid fertilizer comprising the same total phosphate concentration; wherein the soil is a post-planting soil and/or post-harvesting soil.

In some embodiments, the fertilizer at a w/w ratio of between 1:100 and 1.5:100 relative to the soil, enhances the w/w concentration of the phosphorus specie within the soil by at most 100%, at most 90%, at most 80%, at most 60%, at most 50%, at most 40%, at most 30%, at most 20% including any range between compared to a solid fertilizer comprising the same total phosphate concentration. In some embodiments, the soil is a post-planting soil and/or post-harvesting soil.

In some embodiments, the fertilizer at a ratio of between 10 and 30 ton/Hectare, is capable to enhance the w/w concentration of the phosphorus specie within the soil by at least 10%, at least 20%, at least 30%, at least 40%, at least 50%, at least 60%, at least 70%, at least 100%, between 100 and 200%, between 200 and 300%, between 300 and 500%, between 500 and 1000%, between 1000 and 10000% including any range between, compared to an untreated soil.

In some embodiments, the fertilizer at a ratio of between 10 and 30 ton/Hectare, is capable to enhance the w/w concentration of the phosphorus specie within the soil by a value ranging between 5 and 50%, between 5 and 10%, between 10 and 20%, between 20 and 25%, between 25 and 30%, between 30 and 35%, between 35 and 40%, between 40 and 50% including any range between, compared to a solid fertilizer comprising the same total phosphate concentration. In some embodiments, the fertilizer at a ratio of between 10 and 30 ton/Hectare, is capable to enhance the w/w concentration of the phosphorus specie within the soil by a value ranging between 5 and 50% including any range between, compared to a solid fertilizer comprising the same total phosphate concentration; wherein the soil is a post-planting soil and/or post-harvesting soil.

In some embodiments, the fertilizer at a ratio of between 10 and 30 ton/Hectare, is capable to enhance the w/w concentration of the phosphorus specie within the soil sufficient for cultivation of a plant (e.g. above 30 mg/kg Olsen-P).

In some embodiments, the fertilizer at a ratio of between 10 and 30 ton/Hectare, is capable to enhance the w/w concentration of the phytoavailable phosphorus specie within the soil, so as to result in a phytoavailable phosphate concentration within the soil being in a range between 60 and 100 mg/kg, between 60 and 80 mg/kg, between 80 and 90 mg/kg, between 90 and 100 mg/kg including any range between, wherein the soil is a cultivated soil (such as post-planting soil and/or post-harvesting soil).

In some embodiments, the fertilizer at a w/w ratio of between 1:100 and 1.5:100 relative to the soil, enhances the concentration of the phosphorus specie (e.g. phosphate) within the plant or a part thereof (e.g. leaf, fruit, or both) by at least 10 times, at least 20 times, at least 30 times, at least 50 times, at least 70 times, at least 100 times, at least 150 times, at least 200 times compared to an untreated plant, including any range between.

In some embodiments, the fertilizer is capable to enhance the concentration of phosphate within the plant or a part thereof (e.g. leaf, fruit, or both) by a value of between 10 and 100%, between 10 and 20%, between 20 and 30%, between 30 and 40%, between 40 and 50%, between 50 and 60%, between 60 and 70%, between 70 and 100%, between 100 and 200%, compared to a liquid fertilizer being devoid of phosphate, including any range between.

In some embodiments, the fertilizer is capable to enhance the concentration of phosphate within the plant or a part thereof (e.g. leaf, fruit, or both) by a value of between 10 and 100%, between 10 and 20%, between 20 and 30%, between 30 and 40%, between 40 and 50%, between 50 and 60%, between 60 and 70%, between 70 and 100%, between 100 and 200% including any range between, compared to a solid fertilizer having between 3 and 4 times greater total phosphate content.

In some embodiments, the fertilizer at a w/w ratio of between 1:100 and 1.5:100 relative to the soil, is capable to enhance the concentration of phosphate within the plant or a part thereof (e.g. leaf, fruit or both) by a value of between 10 and 100%, between 10 and 20%, between 20 and 30%, between 30 and 40%, between 40 and 50%, between 50 and 60%, between 60 and 70%, between 70 and 100%, between 100 and 200% including any range between, compared to a solid fertilizer having between 3 and 4 times greater total phosphate content.

In some embodiments, the fertilizer at a ratio of between 10 and 30 ton/Hectare, is capable to enhance the concentration of phosphate within the plant or a part thereof (e.g. leaf, fruit or both) by a value of between 10 and 100%, between 10 and 20%, between 20 and 30%, between 30 and 40%, between 40 and 50%, between 50 and 60%, between 60 and 70%, between 70 and 100%, between 100 and 200% including any range between, compared to a solid fertilizer having between 3 and 4 times greater total phosphate content.

Experimental data demonstrating soil and/or plant phosphate accumulation upon implementation of the herein disclosed fertilizer, is described in the examples section.

In some embodiments, the fertilizer at a w/w ratio of between 1:100 and 1.5:100 relative to the soil, is capable to enhance the concentration of the iron specie within the plant or a part thereof (e.g. leaf, fruit, or both) by at least 5%, at least 7%, at least 10%, at least 15%, at least 17%, at least 20%, at least 25%, at least 30%, at least 40%, at least 50%, compared to a control, including any range between. In some embodiments, the fertilizer at a w/w ratio of between 1:100 and 1.5:100 relative to the soil, is capable to enhance the concentration of the iron specie within the plant or a part thereof (e.g. leaf, fruit, or both) by at most 50%, at most 40%, at most 30%, at most 20% compared to a control, including any range between.

In some embodiments, the control comprises a liquid fertilizer comprising the same weight content of the iron specie.

Exemplary data demonstrating soil and/or plant iron accumulation upon implementation of the herein disclosed fertilizer, is described in the examples section.

In some embodiments, the fertilizer is capable of releasing between 20 and 99%, between 20 and 30%, between 30 and 40%, between 40 and 50%, between 50 and 60%, between 60 and 70%, between 70 and 80%, between 80 and 90%, between 90 and 95%, between 95 and 99%, including any range therebetween of the initial content of the phosphorus specie (e.g. phytoavailable phosphorus specie) within a time period of between 1 week (w) and 3 months (m), between 1 and 2 w, between 2 and 4 w, between 4 and 5 w, between 5 and 8 w, between 2 and 3 m including any range therebetween. In some embodiments, releasing comprises desorption of the phytoavailable phosphorus specie bound to the sorbent into a soil, into a plant and/or a part thereof, or both.

In some embodiments, the fertilizer is capable of releasing between 20 and 99% of the initial content of the iron specie (e.g. phytoavailable iron specie) within a time period of 3 months. In some embodiments, releasing comprises desorption of the phytoavailable iron specie (e.g. Fe³⁺ cation) bound to the sorbent is into a soil, into a plant or a part thereof or both.

In some embodiments, the agricultural composition is capable of releasing the phosphorus specie and/or iron specie in a sustained manner. In some embodiments, the agricultural composition is capable of gradually releasing the phosphorus and/or iron specie into the soil. In some embodiments, the agricultural composition is capable of gradually increasing the phosphorus and/or iron uptake into a plant or a part of the plant.

### Methods of Fertilization

According to another aspect of some embodiments of the present invention there is provided a method for enriching a soil with an element, the method comprises contacting an effective amount of the fertilizer of the invention with the soil. In some embodiments, the element is the active substance (e.g. active fertilizing substance), as described herein. In some embodiments, the element is selected from the phosphorus specie, and/or the iron specie, as described herein. In some embodiments, the element is selected form N, P, and K ions are a combination thereof. In some embodiments, the method is for fertilizing a soil, a growth medium, and/or area under cultivation.

In some embodiments, the effective amount of the fertilizer comprises an agriculturally effective amount. In some embodiments, the effective amount of the fertilizer comprises a fertilization effective amount. In some embodiments, the effective amount of the fertilizer is so as to induce a predefined w/w concentration of the active substance within the soil or the area under cultivation. In some embodiments, the effective amount of the fertilizer is so as to result in the predefined w/w concentration of the active substance within the soil or the area under cultivation, upon applying the fertilizer to the soil and/or to the area under cultivation. In some embodiments, the predefined w/w concentration is as described hereinabove.

In some embodiments, the element further comprises the micro element (such as Mg, Ca, S, Fe, Mn, Zn, B, Cu, Mo, and Si), including any salt, a derivative or a combination thereof.

In some embodiments, the method is for enriching a soil, a growth medium, an area under cultivation or any combination thereof, with the element. In some embodiments, enriching comprises increasing a w/w concentration of the element within the soil, the growth medium, the area under cultivation or any combination thereof, by at least 5%, at least 7%, at least 10%, at least 15%, at least 17%, at least 20%, at least 25%, at least 30%, at least 40%, at least 50%, compared to a control, including any range between. In some embodiments, the control is as described herein (e.g. a liquid fertilizer being devoid of the phosphorus specie).

In some embodiments, the effective amount of the fertilizer comprises ratio of the fertilizer to the soil of between 1 and 50 ton/Hectare, between 1 and 5 ton/Hectare, between 5 and 10 ton/Hectare, between 10 and 15 ton/Hectare, between 15 and 20 ton/Hectare, between 20 and 25 ton/Hectare, between 25 and 30 ton/Hectare, between 30 and 40 ton/Hectare, between 40 and 50 ton/Hectare including any range or value therebetween. Each value represents a separate embodiment of the invention.

In some embodiments, the method comprising contacting the effective amount of the fertilizer of the invention with the soil, wherein the effective amount (or agriculturally effective amount) is between 0.1 and 50 ton/Hectare, between 0.1 and 0.5 ton/Hectare, between 0.5 and 1 ton/Hectare, between 1 and 2 ton/Hectare, between 2 and 5 ton/Hectare, between 5 and 10 ton/Hectare, between 10 and 15 ton/Hectare, between 15 and 20 ton/Hectare, between 20 and 25 ton/Hectare, between 25 and 30 ton/Hectare, between 30 and 40 ton/Hectare, between 40 and 50 ton/Hectare including any range or value therebetween. One skilled artisan will appreciate, that the exact dosage of the fertilizer may vary and is dependent on the initial phosphate concentration within the soil.

In some embodiments, the method comprises contacting the fertilizer of the invention with the soil, thereby enhancing the w/w concentration of the phosphorus specie within the soil by at least 10%, at least 20%, at least 30%, at least 40%, at least 50%, at least 60%, at least 70%, at least 100% compared to a control, including any range between. Each value represents a separate embodiment of the invention.

In some embodiments, the method comprises contacting the fertilizer of the invention with the soil, thereby enhancing the w/w concentration of the phosphorus specie within the soil by at most 100%, at most 90%, at most 80%, at most 60%, at most 50%, at most 40%, at most 30%, at most 20% compared to a control, including any range between. In some embodiments, the control is as described herein. Each value represents a separate embodiment of the invention.

In some embodiments, the method comprising contacting the fertilizer of the invention with the soil, wherein a w/w ratio of between the fertilizer and the soil is between 0.1:100 and 10:100, between 0.1:100 and 0.3:100, between 0.3:100 and 0.5:100, between. 05:100 and 1:100, between 1:100 and 1.2:100, between 1.2:100 and 1.5:100, between 1.5:100 and 2:100, between 2:100 and 5:100, between 5:100 and 10:100, including any range between. Each value represents a separate embodiment of the invention.

In some embodiments, contacting is selected from pre-planting, post-planting, pre-seeding, post-seeding, pre-harvesting, and post-harvesting or any combination thereof. The intended use of the fertilizer(s) disclosed herein, is for soil applications either laid on top of the ground or incorporated into the soil. In some embodiments, contacting is by mixing the fertilizer with the soil and/or by applying the fertilizer to the rhizosphere. In some embodiments, the fertilizer is mixed with other dry fertilizer ingredients prior to application or used alone. In some embodiments, the fertilizer is “broadcast” (e.g. scattered) onto the soil, laid down in a “band” on the top of the soil, or injected in a band beneath the soil surface. Various application methods of solid fertilizers are well-known in the art.

Typical application equipment can include farm tractors with hoppers and spreading or injection apparatus attached or pulled behind trailer style, specialized dry fertilizer application vehicles that uniformly spread fertilizer over farm ground, airborne crop dusters outfitted with granular spreading devices, and manual labor hand spreading to targets such as the base of trees or vines.

In some embodiments, the method comprises contacting the fertilizer of the invention with the soil, thereby enhancing the concentration of the phosphorus specie within the plant or a part thereof (e.g. leaf, fruit, or both) by at least 10 times, at least 20 times, at least 30 times, at least 50 times, at least 70 times, at least 100 times, at least 150 times, at least 200 times compared to an untreated plant, including any range between.

In some embodiments, the method comprises enhancing the concentration of the phosphorus specie within the plant or a part thereof (e.g. leaf, fruit, or both) by at least 5%, at least 7%, at least 10%, at least 15%, at least 17%, at least 20%, at least 25%, at least 30%, at least 40%, at least 50%, compared to a control, including any range between. In some embodiments, the method comprises enhancing the concentration of the phosphorus specie within the plant or a part thereof (e.g. leaf, fruit, or both) by at most 50%, at most 40%, at most 30%, at most 20% compared to a control, including any range between. Exemplary data demonstrating soil and/or plant phosphorus accumulation upon implementation of the herein disclosed fertilizer, is described in the examples section.

In some embodiments, the method comprises contacting the fertilizer of the invention with the soil, thereby resulting in phosphate concentration within the soil of between 80 and 100 mg/kg including any range therebetween, wherein contacting is at a w/w ratio of between the fertilizer and the soil is between 1:100 and 1.5:100 including any range between.

In some embodiments, the method comprises contacting the fertilizer of the invention with the soil, thereby resulting in phosphate concentration within the soil of between 80 and 100 mg/kg including any range therebetween, wherein contacting is at a ratio of the fertilizer to the soil is between 2 and 50 ton/Hectare including any range between.

In some embodiments, the method comprises contacting the fertilizer of the invention with the soil, thereby enhancing the concentration of the phosphorus specie within the soil by at least 10 times, at least 20 times, at least 30 times, at least 50 times, at least 70 times, at least 100, at least 150, at least 200 times, including any range between compared to an untreated soil.

In some embodiments, the method comprises contacting the fertilizer of the invention with the soil, thereby enhancing the w/w concentration of the phytoavailable phosphorus specie within the soil up to a range of between 20 and 1000%, between 20 and 1000%, between 20 and 50%, between 50 and 100%, between 100 and 200%, between 200 and 300%, between 300 and 500%, between 500 and 1000%, between 1000 and 10000% including any range between, compared to the untreated soil, wherein the soil is a cultivated soil (such as post-planting soil and/or post-harvesting soil), and wherein contacting is as described herein.

In some embodiments, the method comprises contacting the fertilizer of the invention with the soil, thereby enhancing the w/w concentration of the phytoavailable phosphorus specie within the soil, so as to result in a phytoavailable phosphate concentration within the soil being in a range between 60 and 100 mg/kg, between 60 and 80 mg/kg, between 80 and 90 mg/kg, between 90 and 100 mg/kg including any range between, wherein the soil is a cultivated soil (such as post-planting soil and/or post-harvesting soil).

In some embodiments, the method comprises contacting the fertilizer of the invention with the soil, thereby enhancing the w/w concentration of the phosphorus specie within the soil by at least 10%, at least 20%, at least 30%, at least 40%, at least 50%, at least 60%, at least 70%, at least 100% including any range between, compared to a solid fertilizer comprising the same total phosphate concentration.

In some embodiments, the method comprises contacting the fertilizer of the invention with the soil, thereby enhancing the w/w concentration of the phosphorus specie within the soil by a value ranging between 5 and 50%, between 5 and 10%, between 10 and 20%, between 20 and 25%, between 25 and 30%, between 30 and 35%, between 35 and 40%, between 40 and 50% including any range between, compared to a solid fertilizer comprising the same total phosphate concentration. In some embodiments, the soil is a post-planting soil and/or post-harvesting soil.

In some embodiments, the method comprises contacting the fertilizer with the soil at a ratio of between 10 and 30 ton/Hectare, thereby enhancing the w/w concentration of the phosphorus specie within the soil by at least 10%, at least 20%, at least 30%, at least 40%, at least 50%, at least 60%, at least 70%, at least 100%, between 100 and 200%, between 200 and 300%, between 300 and 500%, between 500 and 1000%, between 1000 and 10000% including any range between, compared to an untreated soil.

In some embodiments, the method comprises contacting the fertilizer of the invention with the soil, thereby enhancing the concentration of the iron specie within the plant or a part thereof (e.g. leaf, fruit, or both) by at least 5%, at least 7%, at least 10%, at least 15%, at least 17%, at least 20%, at least 25%, at least 30%, at least 40%, at least 50%, compared to a control, including any range between. In some embodiments, the method is for enhancing the concentration of the iron specie within the plant or a part thereof (e.g. leaf, fruit, or both) by at most 50%, at most 40%, at most 30%, at most 20% compared to a control, including any range between. In some embodiments, the method comprises contacting the fertilizer of the invention with the soil, wherein a ratio of the fertilizer to the soil is as described herein.

In some embodiments, the method comprises contacting the fertilizer of the invention with the soil, thereby resulting in iron concertation within the soil of between 10 and 50 mg/kg, between 2.5 and 6 mg/kg, between 6 and 10 mg/kg, between 10 and 20 mg/kg, between 20 and 30 mg/kg, between 30 and 40 mg/kg, between 40 and 50 mg/kg including any range therebetween, wherein a ratio of the fertilizer to the soil is as described herein.

In some embodiments, the method comprises contacting the fertilizer of the invention with the soil, thereby resulting in iron concertation within the plant or a part thereof (e.g. fruit) of between 0.02 and 0.08 g/kg including any range therebetween, wherein a ratio of the fertilizer to the soil is as described herein.

Exemplary data demonstrating soil and/or plant iron accumulation upon implementation of the herein disclosed fertilizer, is described in the examples section.

In some embodiments, the method is for increasing phytoavailability of the element within the soil and/or area under cultivation by at least 5%, at least 7%, at least 10%, at least 15%, at least 17%, at least 20%, at least 25%, at least 30%, at least 40%, at least 50%, at least 100%, compared to a control.

In some embodiments, the method is for increasing a concentration of the phytoavailable element within the soil and/or area under cultivation by at least 5%, at least 7%, at least 10%, at least 15%, at least 17%, at least 20%, at least 25%, at least 30%, at least 40%, at least 50%, at least 100%, at least 1000%, at least 10000%, compared to a control. In some embodiments, the control is a solid fertilizer comprising the same total phosphate concentration. In some embodiments, the control is an untreated soil. In some embodiments, the method is for selectively enriching the soil, the growth medium, the area under cultivation or any combination thereof, with the phosphorus specie and/or iron specie, as described herein.

In some embodiments, enhancing and/or increasing as described herein is by at least 10%, least 20%, at least 50%, at least 100%, at least 200%, at least 300%, at least 400%, at least 500%, at least 1000% including any range therebetween. In some embodiments, enhancing and/or increasing is compared to a control, wherein the control is as described herein.

In some embodiments, the method is for maintaining a concentration of the phosphorus and/or iron specie within the soil and/or area under cultivation. In some embodiments, the method is for maintaining a concentration of the phosphorus and/or iron specie at a level sufficient for cultivation of a plant. In some embodiments, the concentrations are as described hereinabove.

Without being limited to any theory, the concentration of the phosphorus specie within the soil appropriate for cultivation has to be at least 6 mg/kg. Without being limited to any theory, the concentration of the iron specie within the soil appropriate for cultivation has to be at least 2.5 mg/kg. In some embodiments, the iron specie is a phytoavailable iron specie, wherein phytoavailable is as described herein.

In some embodiments, the method is for maintaining a concentration of the phosphorus specie in the soil and/or area under cultivation between 6 and 100 mg/kg, between 6 and 10 mg/kg, between 10 and 20 mg/kg, between 20 and 50 mg/kg, between 50 and 70 mg/kg, between 70 and 100 mg/kg, including any range between, wherein the method comprises contacting the fertilizer with the soil as described herein.

In some embodiments, the method is for maintaining a concentration of the iron specie in the soil and/or area under cultivation between 2.5 and 50 mg/kg, between 2.5 and 5 mg/kg, between 5 and 10 mg/kg, between 10 and 20 mg/kg, between 20 and 50 mg/kg, including any range between, wherein the method comprises contacting the fertilizer with the soil as described herein.

In some embodiments, the method is for maintaining a concentration of the phosphorus and/or iron specie in the soil and/or area under cultivation within a time period ranging between 1 week (w) and 1 year (y), between 1 and 4 w, between 1 and 3 months (m), between 3 and 5 m, between 5 and 7 m, between 7 and 9 m, between 9 and 12 m, including any range therebetween, wherein the concentration of the phosphorus and/or iron specie is as described herein.

In some embodiments, the method is for preventing and/or reducing deficiency of the phosphorus specie in the soil and/or area under cultivation.

In some embodiments, the method is for enhancing a yield of a plant, a growth of a plant (e.g. height and/or weight of plant material). In some embodiments, the method is for enhancing a plant yield and/or a plant growth by a value of between 5 and 100%, between 5 and 10%, between 10 and 20%, between 20 and 25%, between 25 and 30%, between 30 and 35%, between 35 and 40%, between 40 and 50%, between 50 and 70%, between 70 and 90%, between 90 and 100%, including any range between. In some embodiments, the method is for enhancing a yield of a plant, a growth of a plant, wherein enhancing is compared to a solid fertilizer comprising the same total phosphate concentration.

In some embodiments, the plant is a crop plant. In some embodiments, the plant is an annual and/or perennial plant.

Non-limiting examples crop plant include but are not limited to: maize, wheat, rye, oat, triticale, rice, barley, sorghum, millet, sugarcane, soybean, peanut, cotton, rapeseed and canola, manihot, pepper, sunflower and tagetes, solanaceous plants like potato, tobacco, eggplant, and tomato, Vicia species, pea, alfalfa, bushy plants (coffee, cacao, tea), Salix species, trees (oil palm, coconut, decorative tree plantings, vineyards, citrus, nut, banana, coffee, tea, rubber, cocoa plantations, a soft fruit), perennial grasses, and forage crops, or any combination thereof.

### Methods of Treating Water (Sorbent of the Invention)

According to another aspect of some embodiments of the present invention there is provided a method for treating a water contaminated with a phosphorus specie, comprising contacting the water with the sorbent of the invention under appropriate conditions, thereby reducing a concentration of the phosphorus specie within the water. In some embodiments, the water is contaminated water. In some embodiments, the method is for treating any liquid contaminated with a phosphorus specie. The liquid can be an aqueous solution, a polar solvent (e.g. ethanol, methanol, acetonitrile etc.) or a mixture thereof. In some embodiments, the liquid as described herein, comprises the organic material and the phosphorus specie, wherein the organic material and the phosphorus specie are as described hereinabove.

In some embodiments, the terms “phosphorus specie” and “phosphorus” are used interchangeably hereinthroughout and may refer to the TP or TDP, as disclosed herein.

In some embodiments, the method is for reducing phosphorus concentration within the contaminated water. In some embodiments, reducing is by at least 20%, at least 50%, at least 60%, at least 70%, at least 80%, at least 90%, at least 95%, at least 97%, at least 99% of the initial phosphorus concentration within the contaminated water, including any range therebetween.

In some embodiments, the method is for manufacturing the composition of the invention. In some embodiments, the method is for manufacturing the composition comprising the sorbent enriched with the phosphorus specie and optionally with the organic material. In some embodiments, the method is for enriching the sorbent of the invention with the phosphorus specie of the invention. In some embodiments, the method is for enriching Fe-WTR with the phosphorus specie of the invention and optionally with the organic material of the invention.

In some embodiments, appropriate conditions comprise incubation time sufficient for removing at least 30%, at least 40%, at least 50%, at least 60%, at least 70%, at least 80%, at least 90%, at least 95%, at least 97%, at least 99% of the initial phosphorus concentration in the contaminated water, including any range or value therebetween.

In some embodiments, appropriate conditions comprise incubation time of at least 10 hours (h), at least 1 h, at least 2 h, at least 3 h, at least 5 h, at least 7 h, at least 10 h, at least 15 h, at least 20 h, at least 1 d, at least 2 d, at least 3 d, including any range therebetween.

In some embodiments, appropriate conditions comprise incubation at a temperature of between 1 and 5° C., between 5 and 10° C., between 10 and 50° C., between 10 and 20° C., between 20 and 30° C., between 30 and 40° C., between 40 and 50° C., including any range therebetween. In some embodiments, appropriate conditions comprise incubation at ambient temperature.

In some embodiments, appropriate conditions comprising a weight per volume ratio between the sorbent and the contaminated water of between 2 and 4 gr/L, between 2 and 2.5 gr/L, between 2.5 and 3 gr/L, between 3 and 3.5 gr/L, between 3.5 and 4 gr/L, between 4 and 5 gr/L, between 5 and 10 gr/L, between 10 and 12 gr/L, between 12 and 15 gr/L, between 15 and 20 gr/L, including any range therebetween. Without being limited to any particular theory, it has been found, that a ratio between the sorbent and the contaminated water of between 2.7 and 3.3 gr/L is optimal for obtaining a maximal enrichment of the sorbent with phytoavailable phosphorus species.

In another aspect, there is provided a method comprising contacting water contaminated with a phosphorus specie with the sorbent of the invention under appropriate conditions, wherein appropriate conditions are sufficient for reducing a concentration of the phosphorus specie within the water thereby obtaining a treated water in contact with a phosphorus enriched sorbent; and subsequently separating the phosphorus enriched sorbent from the treated water. In some embodiments, the appropriate conditions are as described herein. In some embodiments, the method is for treating contaminated water. In some embodiments, the method is for manufacturing the phosphorus enriched sorbent (i.e. the fertilizer of the invention). In some embodiments, the method comprises a pretreatment step performed prior to the contacting step, wherein the pretreatment step is as described herein (e.g. pretreatment with NC disclosed herein).

In some embodiments, the method for manufacturing the phosphorus enriched sorbent further comprises a step of drying the saturated sorbent. In some embodiments, the method further comprises a step of grinding a dry saturated sorbent, so as to obtain a predefined particle size of the phosphorus enriched sorbent.

In some embodiments, contacting comprises providing the sorbent and contacting the sorbent with the contaminated water (or any other fluid), thereby obtaining the sorbent saturated with the phosphorus specie. In some embodiments, contacting comprises providing the sorbent and mixing or agitating the sorbent with the contaminated water. In some embodiments, the method further comprises a step of separating the saturated sorbent from the clarified water (e.g. by a process selected from centrifugation, precipitation, filtration, or any combination thereof).

In some embodiments, the method further comprises repeating the contacting step. In some embodiments, the method comprises successively repeating the contacting step and the separation step, wherein repeating is for one or more times.

In some embodiments, contacting is performed in a reactor (e.g. a batch reactor). In some embodiments, contacting comprises providing the sorbent and circulating the contaminated water (or any other fluid) through the sorbent, thereby saturating the sorbent with the phosphorus specie. In some embodiments, circulating comprises continuous circulating of the contaminated water (or any other fluid) through the sorbent. In some embodiments, circulating is performed in a continuous flow reactor.

In some embodiments, the contaminated water comprises wastewater from dairy industry, olive oil mill, wineries, piggeries, cowsheds, slaughterhouses, fruit and vegetable processing industry, or soy or coffee bean industry or a combination thereof. In some embodiments, the wastewater is a recreational water from a coastal beach, lake, river, or pond. In some embodiments, the wastewater comprises dairy wastewater.

In some embodiments, the contaminated water comprises a drinking water or a source thereof, wherein the drinking water or a source thereof is from a river, a lake, a reservoir, a pond, a stream, groundwater, spring water, surface water, and/or seawater or combinations thereof.

In some embodiments, the method of the invention comprises a pretreatment step, performed prior to the step of contacting the water with the sorbent of the invention.

In some embodiments, the pretreatment step comprises providing the liquid (e.g. contaminated water) and at least partially removing total suspended solids (TSS) therefrom. In some embodiments, the pretreatment step comprises performing any one of centrifugation of the liquid, treating the liquid with a nanocomposite (NC), or both, thereby removing at least a portion of the TSS form the liquid.

Pretreatment of the wastewater having a high content of TSS and/or turbidity by either centrifugation or by contacting thereof with NC is well known in the art. In some embodiments, the NC comprises a clay particle (e.g. kaolinite, sepiolite, palygorskite, smectite, montmorillonite, hectorite, laponite, bentonite, and saponite) or a zeolite; and a positively charged polymer (e.g. a cationic polymer comprising any of chitosan, poly (diallyl dimethylammonium) chloride (poly-DADMAC), cationic polyacrylamide, quaternized hydroxy ethylcellulose ethoxylate, poly [(2-ethyldimethylammonioethyl methacrylate ethyl sulfate)-co-(1-vinylpyrrolidone)], cationic guar gum, poly-4-vinylpyridine-co-styrene, etc.). Other NCs suitable for removing of TSS and/or turbidity are well known in the art.

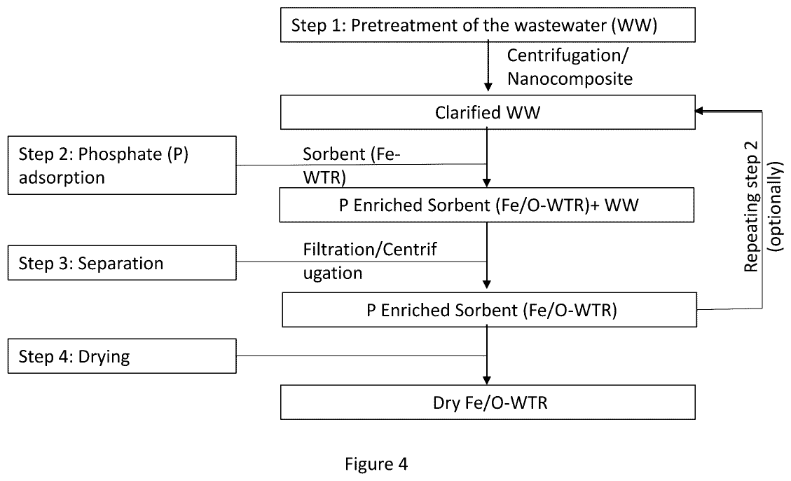

In some embodiments, the method of the invention is illustrated in FIG. 4.

### Methods of Treating Water (Phosphorus Sorbent)

According to another aspect of some embodiments of the present invention there is provided a method for treating a water contaminated with a phosphorus specie, comprising pretreating the contaminated water with a nano-composite, under conditions sufficient for removal of at least 80% of suspended solids (also referred to herein as total suspended solids, abbreviated TSS) from the contaminated water, thereby obtaining a clarified water; and contacting the clarified water with the sorbent of the invention under appropriate conditions, thereby removing at least 60% of the phosphorus specie from the contaminated water. In some embodiments, the method is for manufacturing the phosphorus enriched sorbent of the invention. In some embodiments, the method is for enriching Fe-WTR with the phosphorus specie of the invention and optionally with the organic material of the invention.

In some embodiments, the method is for treating any liquid contaminated with a phosphorus specie. The liquid can be an aqueous solution, a polar solvent (e.g. ethanol, methanol, acetonitrile etc.) or a mixture thereof. In some embodiments, the liquid as described herein, comprises the organic material and the phosphorus specie, wherein the organic material and the phosphorus specie are as described hereinabove. In some embodiments, the contaminated water is or comprises a wastewater.

In some embodiments, the terms “phosphorus specie” and “phosphorus” are used interchangeably herein throughout. In some embodiments, the phosphorus specie refers to TP of the contaminated water. In some embodiments, the phosphorus specie comprises a water soluble phosphorus specie and optionally a water insoluble specie present within the contaminated water. In some embodiments, the phosphorus specie refers to organic and/or inorganic phosphate present within the suspended solids of the contaminated water.

In some embodiments, the contaminated water, as used herein, comprises wastewater from dairy industry, olive oil mill, wineries, piggeries, cowsheds, slaughterhouses, fruit and vegetable processing industry, or soy or coffee bean industry or a combination thereof. In some embodiments, the wastewater is a recreational water from a coastal beach, lake, river, or pond. In some embodiments, the wastewater comprises dairy wastewater.

In some embodiments, the contaminated water comprises a drinking water or a source thereof, wherein the drinking water or a source thereof is from a river, a lake, a reservoir, a pond, a stream, groundwater, spring water, surface water, and/or seawater or combinations thereof.

In some embodiments, the method is for reducing phosphorus concentration within the contaminated water. In some embodiments, reducing is by at least 50%, at least 60%, at least 70%, at least 80%, at least 90%, at least 95%, at least 97%, at least 99% of the initial phosphorus concentration within the contaminated water, including any range therebetween. In some embodiments, the initial phosphorus concentration refers to the TDP of the contaminated water (e.g. wastewater).

In some embodiments, the method of the invention comprises a pretreatment step, performed prior to the step of contacting the water with the sorbent of the invention (or phosphorus sorption step).

In some embodiments, the pretreatment step comprises providing the liquid (e.g. contaminated water) and at least partially removing total suspended solids (TSS) therefrom, thereby obtaining a clarified water. In some embodiments, the term at least partially removing TSS refers to removal of at least 80%, at least 85%, at least 90%, at least 92%, at least 95%, at least 97%, at least 99% of the initial TSS, including any range between, wherein the initial TSS refers to TSS of the contaminated water prior to performing the pretreatment step. In some embodiments, the pretreatment step is also referred to herein as the water clarification step. In some embodiments, the clarified water obtained upon performing the pretreatment or clarification step, is characterized by reduced turbidity, as compared to the contaminated water prior to performing the pretreatment step.

In some embodiments, upon completion of the pretreatment step, the turbidity of the clarified water is reduced by at least at least 50%, at least 60%, at least 70%, at least 80%, at least 85%, at least 90%, at least 92%, at least 95%, at least 97%, at least 99%, including nay range between. One skilled in the art will appreciate, that water turbidity can be measured according to standard procedures known in the art. Accordingly, one skilled in the art can determine the end point of the pretreatment step by analyzing TSS or turbidity of the clarified water.

In some embodiments, the clarified water as used herein, is characterized by a turbidity of at most 200 NTU, at most 100 NTU, at most 50 NTU, at most 30 NTU, at most 20 NTU, including any range between.

In some embodiments, the pretreatment step comprises performing any one of centrifugation of the liquid (e.g. contaminated water); and contacting the liquid with a coagulant, or both. In some embodiments, the coagulant is or comprises the nanocomposite (NC) of the invention.

In some embodiments, the pretreatment step of the invention comprises contacting the contaminated water with NC of the invention under appropriate conditions, thereby obtaining a clarified water. In some embodiments, the pretreatment step of the invention comprises contacting the contaminated water with a sufficient amount of NC of the invention, thereby obtaining a clarified water. In some embodiments, the pretreatment step of the invention comprises contacting the contaminated water with a sufficient amount of NC of the invention, so as to clarify the contaminated water. In some embodiments, the pretreatment step is performed under conditions sufficient for removal of at least 80% of the initial TSS, as described herein.

In some embodiments, the pretreatment step comprises contacting the contaminated water with the NC for a time period sufficient for removal of at least 80% of the initial TSS, wherein the sufficient time period is at least 1 minute (m), or less. In some embodiments, the sufficient time period is at least 1 minute (m), at least 3 m, at least 5 m, at least 10 m, at least 15 m, at least 20 m, at least 30 m, including any range between.

In some embodiments, the sufficient time period ranges from 1 to 60 minutes (m), from 1 to 5 m, from 5 to 10 m, from 10 to 15 m, from 15 to 20 m, from 20 to 30 m, from 30 to 60 m, including any range between. The exact time period may be determined as described hereinabove.

In some embodiments, contacting the contaminated water with the NC further comprises mixing or agitating the contaminated water and the NC for a sufficient time period, as described herein. In some embodiments, contacting the contaminated water is performed under ambient conditions comprising a temperature of between 1 and 60° C., between 1 and 5° C., between 5 and 10° C., between 10 and 50° C., between 10 and 20° C., between 20 and 30° C., between 30 and 40° C., between 40 and 50° C., including any range therebetween. In some embodiments, appropriate conditions comprise incubation at ambient temperature.

In some embodiments, the pretreatment step comprises contacting the contaminated water with an amount of NC sufficient for obtaining the clarified water, as described herein. In some embodiments, the amount of NC is sufficient for removal of at least 80% of the initial TSS. In some embodiments, the sufficient amount of NC comprises a w/w concentration of at least 0.1%.

In some embodiments, the sufficient amount of NC is between 0.1 and 10%, between 0.1 and 0.3%, between 0.3 and 0.5%, between 0.5 and 0.7%, between 0.7 and 1%, between 1 and 3%, between 3 and 5%, between 5 and 10%, by weight of the contaminated water including any range between. In some embodiments, the sufficient amount of NC is so as to maintain at least 80%, at least 90%, or more of the initial TDP, wherein the initial TDP is as described herein.

In some embodiments, the sufficient amount of NC comprises a w/w ratio between the NC and the initial TSS of at least 10:1, at least 50:1, at least 70:1, at least 90:1, at least 100:1, at least 500:1, at least 700:1, at least 900:1, at least 1000:1, at least 1500:1, at least 2000:1, including any range between.

In some embodiments, the pretreatment step substantially maintains the phosphate content of the contaminated water. In some embodiments, the pretreatment step substantially maintains the TDP of the contaminated water. In some embodiments, TDP of the clarified water (e.g. wastewater after pretreatment) remains substantially the same, as compared to the initial TDP of the untreated contaminated water (e.g. wastewater before pretreatment).

In some embodiments, TDP of the clarified water is at least 80%, at least 85%, at least 90%, at least 92%, at least 95%, at least 97%, at least 99% of the initial TDP (e.g. TDP of wastewater before pretreatment).

Various methods for clarification of wastewater having high content of TSS and/or turbidity are well known in the art, including inter alia centrifugation or contacting wastewater with a coagulant. Exemplary coagulants are clay particles, or a mixture (e.g. kit or subsequent treatment) of a clay particle and a polymer (e.g. a positively charged polymer).

In some embodiments, the NC of the invention comprises one or more NCs. In some embodiments, the NC is or comprises a composite. In some embodiments, the composite comprises a clay particle and a positively charged polymer absorbed or bound thereto. In some embodiments, the positively charged polymer is in contact with or bound to the outer surface of the clay particle. In some embodiments, the NC is stable (e.g. substantially devoid of disintegration) under conditions of the pretreatment step, as described herein.

Non-limiting examples of clay particles include but are not limited to clay mineral(s) such as sepiolite, palygorskite, attapulgite, smectite, montmorillonite, bentonite, hectorite, kaolinite, halloysite, saponite and vermiculite; non-clay mineral(s) such as quartz, diatomaceous earth, and zeolites; or any combination thereof.

Non-limiting examples of cationic polymers (e.g. polymers having an intrinsic positive charge or ionizable polymers capable of undergoing protonation) include but are not limited to poly (diallyl dimethylammonium) chloride (poly-DADMAC), cationic polyacrylamide, polyethyleneimine (branched or linear) optionally modified by an alkyl group, poly [(2-ethyldimethylammonioethyl methacrylate ethyl sulfate)-co-(1-vinylpyrrolidone)]; a polyquaternium (e.g. Polyquaternium 10, Polyquaternium 11, Polyquaternium 15); a cationic polysaccharide (e.g. cationic guar gum, quaternized hydroxy ethylcellulose ethoxylate, and chitosan); a styrene-based cationic polymer (e.g. poly-4-vinylpyridine-co-styrene); including any copolymer or any combination thereof.

In some embodiments, the method of the invention further comprises performing a primary sedimentation step of the contaminated water, wherein the primary sedimentation is performed prior to the pretreatment step. In some embodiments, the primary sedimentation is performed so as to remove rough solids from the contaminated water. In some embodiments, primary sedimentation comprises providing the contaminated water to a container (e.g. a settling tank) and retaining the contaminated water within the container under ambient conditions, for a time period (e.g. between 10 min and 10 hours, including any range between) sufficient for removal of a portion of the TSS by gravity settling or precipitation. Primary sedimentation process is a well-known procedure in the wastewater treatment industry.

In some embodiments, the method further comprises repeating the pretreatment step one or more times (e.g. 1, 2, 3, 4, or 5, etc.).

In some embodiments, the method of the invention comprises contacting the clarified water with the sorbent of the invention (e.g. Fe-WTR) under appropriate conditions, wherein contacting is performed subsequently to the pretreatment step. In some embodiments, contacting step (also used herein as phosphate sorption) is performed under appropriate conditions sufficient for removing at least 50%, at least 60%, at least 65%, at least 70%, at least 75%, at least 80%, at least 85%, at least 87%, at least 89%, at least 90%, at least 92%, at least 95%, of the phosphorus specie from the contaminated water.

In some embodiments, appropriate conditions comprise incubation time sufficient for removing at least 30%, at least 40%, at least 50%, at least 60%, at least 70%, at least 80%, at least 90%, at least 95%, at least 97%, at least 99% of the TDP in the clarified water, including any range or value therebetween. Accordingly, the progress and/or end point of the sorption step can be determined by monitoring TDP of the clarified water in contact with the sorbent.

In some embodiments, appropriate conditions comprise incubation time of at least 10 hours (h), at least 0.1 h, at least 0.5 h, at least 1 h, at least 2 h, at least 3 h, at least 5 h, at least 7 h, at least 10 h, at least 15 h, at least 20 h, at least 1 d, at least 2 d, at least 3 d, including any range therebetween.

In some embodiments, appropriate conditions comprise incubation at a temperature of between 1 and 5° C., between 5 and 10° C., between 10 and 50° C., between 10 and 20° C., between 20 and 30° C., between 30 and 40° C., between 40 and 50° C., including any range therebetween. In some embodiments, appropriate conditions comprise incubation at ambient temperature.

In some embodiments, appropriate conditions comprising a weight per volume ratio between the sorbent and the clarified water of between 0.5 and 15 gr/L, between 0.5 and 1 gr/L, between 1 and 2 gr/L, between 2 and 2.5 gr/L, between 2.5 and 3 gr/L, between 3 and 3.5 gr/L, between 3.5 and 4 gr/L, between 4 and 5 gr/L, between 5 and 10 gr/L, between 10 and 12 gr/L, between 12 and 15 gr/L, between 15 and 20 gr/L, including any range therebetween.

In some embodiments, appropriate conditions comprise incubation time sufficient for sorption of at least 50%, at least 60%, at least 70%, at least 80%, at least 90%, at least 95%, at least 97%, at least 99% of the TDP in the clarified water by the sorbent.

In some embodiments, contacting comprises providing the sorbent and contacting the sorbent with the clarified water (or any other fluid), thereby obtaining the phosphorus enriched sorbent of the invention. In some embodiments, contacting comprises providing the sorbent and mixing or agitating the sorbent with the clarified water within a time range as described hereinabove.

In some embodiments, the method further comprises repeating the contacting step one or more times (e.g. 1, 2, 3, 4, or 5, etc.).

In some embodiments, contacting is performed in a reactor (e.g. a batch reactor). In some embodiments, contacting comprises providing the sorbent and circulating the clarified water (or any other fluid) through the sorbent, thereby saturating or enriching the sorbent with the phosphorus specie. In some embodiments, circulating comprises continuous circulating of the clarified water (or any other fluid). In some embodiments, circulating is performed in a continuous flow reactor.

In some embodiments, the method further comprises a step of separating the phosphorus enriched sorbent from the clarified water (e.g. by a process selected from centrifugation, precipitation, filtration, or any combination thereof). In some embodiments, the method comprises successively repeating the contacting step and the separation step, wherein repeating is one or more times.

According to another aspect of some embodiments of the present invention there is provided a method for treating water contaminated with a phosphorus specie, comprising pretreating the contaminated water with a nano-composite, under conditions sufficient for removal of at least 80% of suspended solids (also referred to herein as total suspended solids, abbreviated TSS) from the contaminated water, thereby obtaining a clarified water; and contacting the clarified water with a phosphorus sorbent under conditions sufficient for substantially removing the phosphorus specie from the clarified water, thereby obtaining a reclaimed water.

In some embodiment, the pretreatment step is as described herein. In some embodiments, the amount of the NC sufficient to obtain the clarified water is between 0.001 and 10%, is between 0.001 and 0.05%, is between 0.05 and 0.01%, is between 0.01 and 10%, is between 0.01 and 0.1%, is between 0.1 and 10%, between 0.1 and 0.3%, between 0.3 and 0.5%, between 0.5 and 0.7%, between 0.7 and 1%, between 1 and 3%, between 3 and 5%, between 5 and 10%, by weight of the contaminated water including any range between.

In some embodiments, the clarified water is as described herein. In some embodiments, the reclaimed water refers to water suitable for recycling. It should be apparent that the term “reclaimed water” encompasses water which at least meets the regulatory standards in any specific jurisdiction, so that the reclaimed water may be recycled or disposed into a reservoir or into a natural water source such as lake, pond, sea, ocean, etc. Especially, the regulatory standards prescribe a maximum amount of common pollutants (such as, metals, heavy metals, nitrogen species, phosphorus species, etc.). Specifically, the term “reclaimed water” may encompass water having different thresholds of pollutants such as phosphorus specie.

In an exemplary embodiment, the concentration of the phosphorus specie within the reclaimed water is at most 10 mg/L, at most 8 mg/L, at most 6 mg/L, at most 4 mg/L, at most 2 mg/L, at most 1 mg/L, at most 0.5 mg/L, at most 0.1 mg/L, including any range between.

In some embodiments, the method comprises contacting the clarified water with a phosphorus sorbent under conditions sufficient for substantially removing the phosphorus specie from the clarified water (also used herein as the “sorption step”), thereby obtaining a reclaimed water.

In some embodiments, the sorption step comprises incubation time sufficient for removing at least 70%, at least 80%, at least 90%, at least 95%, at least 97%, at least 99%, at least 99.5%, at least 99.9% of the TDP in the clarified water, including any range or value therebetween. In some embodiments, the contacting step comprises incubation time sufficient for removing TDP so as to obtain the reclaimed water. Accordingly, the incubation time and/or number of repeats of the sorption step may vary, based on the desired end concentration of P in the reclaimed water (predetermined by the regulations). The progress and/or end point of the sorption step can be determined by monitoring TDP of the reclaimed water.

In some embodiments, the sorption step comprises incubation time (or contacting time with the clarified water) of at least 10 hours (h), at least 0.1 h, at least 0.5 h, at least 1 h, at least 2 h, at least 3 h, at least 5 h, at least 7 h, at least 10 h, at least 15 h, at least 20 h, at least 1 d, at least 2 d, at least 3 d, including any range therebetween.

In some embodiments, the sorption step is performed at a temperature of between 1 and 5° C., between 5 and 10° C., between 10 and 50° C., between 10 and 20° C., between 20 and 30° C., between 30 and 40° C., between 40 and 50° C., including any range therebetween. In some embodiments, the sorption step is performed at ambient temperature (e.g. between 15 and 40° C.).

In some embodiments, the sorption step comprising a weight per volume ratio between the phosphorus sorbent and the clarified water of between 0.01 and 50 gr/L, between 0.01 and 0.05 gr/L, between 0.05 and 0.1 gr/L, between 0.1 and 0.3 gr/L, between 0.3 and 0.5 gr/L, between 0.5 and 15 gr/L, between 0.5 and 1 gr/L, between 1 and 2 gr/L, between 2 and 2.5 gr/L, between 2.5 and 3 gr/L, between 3 and 3.5 gr/L, between 3.5 and 4 gr/L, between 4 and 5 gr/L, between 5 and 10 gr/L, between 10 and 12 gr/L, between 12 and 15 gr/L, between 15 and 20 gr/L, between 20 and 50 gr/L, including any range therebetween.

In some embodiments, a w/w ratio between the phosphorus sorbent and the TDP of the clarified water (or of the contaminated water) is between 1000:1 and 10:1, between 1000:1 and 800:1, between 800:1 and 500:1, between 500:1 and 300:1, between 300:1 and 200:1, between 200:1 and 100:1, between 100:1 and 50:1, between 50:1 and 30:1, between 30:1 and 10:1, including any range therebetween.

In some embodiments, contacting comprises providing the phosphorus sorbent and contacting the phosphorus sorbent with the clarified water (or any other fluid), under conditions sufficient for obtaining the reclaimed water. In some embodiments, contacting comprises providing the phosphorus sorbent and mixing or agitating the phosphorus sorbent with the clarified water with a time range and at a temperature as described hereinabove.

In some embodiments, the method further comprises repeating the contacting step one or more times (e.g. 1, 2, 3, 4, or 5, etc.).

In some embodiments, contacting is performed in a reactor (e.g. a batch reactor). In some embodiments, contacting comprises providing the phosphorus sorbent and circulating the clarified water (or any other fluid) through the phosphorus sorbent, thereby saturating or enriching the phosphorus sorbent with the phosphorus specie. In some embodiments, circulating comprises continuous circulating of the clarified water (or any other fluid). In some embodiments, circulating is performed in a continuous flow reactor.

In some embodiments, the method further comprises a step of separating the phosphorus sorbent from the reclaimed water (e.g. by a process selected from centrifugation, precipitation, filtration, or any combination thereof). In some embodiments, the method comprises successively repeating the sorption step and the separation step, wherein repeating is one or more times.

In some embodiments, the method further comprises performing a primary sedimentation step of the contaminated water, wherein the primary sedimentation is performed prior to the pretreatment step. In some embodiments, the primary sedimentation is performed so as to remove rough solids from the contaminated water. In some embodiments, primary sedimentation comprises providing the contaminated water to a container (e.g. a settling tank) and retaining the contaminated water within the container under ambient conditions, for a time period (e.g. between 10 min and 10 days, including any range between) sufficient for removal of a portion of the TSS by gravity settling or precipitation. Primary sedimentation process is a well-known procedure in the wastewater treatment industry.

In some embodiments, the phosphorus sorbent in from of a particulate matter. In some embodiments, the sorbent is in from of a particulate matter. In some embodiments, the phosphorus sorbent is characterized by an average particle size between 10 μm and 1000 μm. In some embodiments, the average particle size between 10 μm and 20 μm, between 10 μm and 12 μm, between 12 μm and 15 μm, between 15 μm and 17 μm, between 17 μm and 20 μm, between 20 μm and 30 μm, between 30 μm and 40 μm, between 40 μm and 50 μm, between 50 μm and 100 μm, between 100 μm and 200 μm, between 200 μm and 300 μm, between 300 μm and 400 μm, between 400 μm and 500 μm, between 500 μm and 700 μm, between 700 μm and 1000 μm, including any range or value therebetween. In some embodiments, the average particle size refers to an average size of dry particles.

In some embodiments, the particulate matter has a surface area of between 100 and 2000 m²/g, between 100 and 500 m²/g, between 500 and 600 m²/g, between 600 and 700 m²/g, between 700 and 800 m²/g, between 800 and 900 m²/g, between 900 and 1000 m²/g, between 1000 and 1200 m²/g, between 1200 and 1500 m²/g, between 1500 and 1700 m²/g, between 1700 and 2000 m²/g, including any range between. In some embodiments, the particle has a surface area of between 900 and 1000 m²/g.

In some embodiments, the phosphorus sorbent comprises any inorganic and/or organic solid (crystalline or amorphous) capable of absorbing a phosphorus specie (e.g., TDP) from an aqueous solution. In some embodiments, the phosphorus sorbent is capable of absorbing a phosphorus specie from an aqueous solution in an amount sufficient for obtaining reclaimed water, having a TDP content as described herein. In some embodiments, the phosphorus sorbent is capable of absorbing a phosphorus specie from an aqueous solution in an amount between about 0.5 and about 10 g (P) per 1 kg of the phosphorus sorbent, including any range between. In some embodiments, the phosphorus sorbent comprises a natural or a synthetic inorganic sorbent. Non-limiting examples of phosphorus sorbents suitable for utilization in the process disclosed herein include but are not limited to WTR (e.g. Fe-WTR, Al-WTR), layered double hydroxide, layered double oxide, apatite (e.g., hydroxyapatite, fluorapatite, chlorapatite, etc.), gravel, laterite, limestone, maerl, marble, opoka, peat, shale, wollastonite, coal fly ash, red mud (a by-product from bauxite), slag, alunite, Filtra P, lightweight aggregate (such as Filtralite), Norlite, polonite, blast furnace slag, or any combination thereof.

In some embodiments, the phosphorus sorbent comprises WTR (e.g. Fe-WTR), layered double hydroxide (synthetic or natural), layered double oxide (synthetic or natural), or any combination thereof. In some embodiments, the LDH (layered double hydroxide) refers to a Mg/Al hydroxide, with various ratios between Mg and Al. Exemplary LDH is as exemplified herein (LDHFr). Additional LDH are well-known in the art.

In some embodiments, layered double oxides refers to a mixed Mg-oxide and Al-oxide, with various ratios between Mg and Al. Exemplary layered double oxides is as exemplified herein (LDHNe). Additional layered double oxides are well-known in the art.

In some embodiments, the method of treating water further comprises performing a disinfection step, by contacting the reclaimed water with a disinfectant. In some embodiments, the disinfection step is for obtaining a reclaimed water. In some embodiments, the disinfection step is for reducing the microbial loading of the reclaimed water. In some embodiments, the term “reducing” as used herein, refers to a substantial reduction of CFU in the treated water so as to obtain water with a microbial load (CFU) which meets the regulatory standards (such as standards for reclaimed water, water suitable for agricultural use, water suitable for recycling or disposal, or potable water). In some embodiments, the disinfection step is performed under conditions suitable for obtaining potable water. In some embodiments, potable water is suitable for human consumption (e.g. characterized by a maximum CFU allowable for human consumption).

In some embodiments, the disinfectant is any microbicidal agent suitable for use in the water treatment. In some embodiments, the disinfectant is an antibacterial agent suitable for use in the water treatment (e.g. chlorine, hypochlorite, etc.). Additional examples of disinfectants are well known in the art. In some embodiments, the disinfectant comprises a NC, as disclosed herein.

### Fertilizer Manufacturing Process

The present invention in some embodiments thereof is at least partially based on a surprising finding, that a pretreatment (e.g. clarification) of the wastewater by nano-composites resulted in an enhanced phosphate sorption performance by the sorbent of the invention (Fe-WTR), compared to a pretreatment by centrifugation. Furthermore, wastewater pretreatment by nano-composites not only resulted in substantial removal of the total dissolved solids (TSS), but also it didn't reduce the initial content of the soluble phosphate in the wastewater. Accordingly, it is postulated that wastewater pretreatment by nano-composites is superior over other clarification methods, since it selectively removes TSS and results in an enhanced phosphate sorption capacity of the sorbent of the invention.

According to one aspect there is provided a method for manufacturing a phosphorus enriched sorbent, comprising a pretreatment step, the pretreatment step comprises pretreating a water contaminated with a phosphorus specie with a nano-composite, under conditions sufficient for removal of at least 80% of suspended solids from the water, thereby obtaining a clarified water; and further comprising a contacting step, wherein the contacting step comprises contacting the clarified water with a sorbent under conditions sufficient for removal of at least 50% of the phosphorus specie from the water, thereby obtaining the phosphorus enriched sorbent (or the fertilizer of the invention), wherein the sorbent is as described herein. In some embodiments, the pretreating step is as described hereinabove. In some embodiments, the sorption step is as described hereinabove.

In some embodiments, the method further comprises a step of drying the enriched sorbent. In some embodiments, the method further comprises a step of grinding a dry enriched sorbent, so as to obtain a predefined particle size of the enriched sorbent.

Various embodiments and aspects of the present invention as delineated hereinabove and as claimed in the claims section below find experimental support in the following examples.

### EXAMPLES

### Example 1

### Manufacturing of Phosphorus Enriched Sorbent

Iron-based water treatment residuals (Fe-WTR) were collected from Soreq or form Palmahim Desalination plant, Israel, after pre-treating seawater, usually containing 0.0002-0.002 mgL⁻¹ of phosphate (P) by media filters. The WTRs were air-dried and crushed to pass a 2 mm sieve. In all experiments, inorganic orthophosphate (soluble reactive P; SRP) was determined by the molybdenum-blue colorimetric method, using an auto-analyzer (SKALAR S++, The Netherlands) and the total dissolved P (TDP) was measured as orthophosphate following autoclave acidic digestion (the method is described in greater detail in Tiessen et. al., 1993. Characterization of available p by sequential extraction. In: Carter, M. R. (Ed.), Soil Sampling and Methods of Analysis. Lewis Publishers, pp. 75-86).

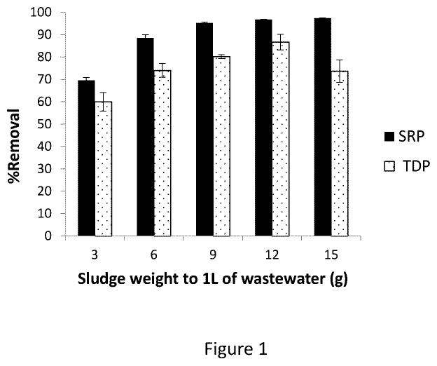

To determine the optimal solid to liquid ratios in order to obtain the most efficient phosphorus loading onto the Fe-WTR, P loading onto Fe-WTR was performed by mixing Fe-WTR and dairy WW (˜43 mg SRP L⁻¹) at a various ratios ranging between 3 and 15 g L⁻¹ for 3 days, resulting in removal of up to 97% of soluble reactive phosphorus (SRP) and up to 77% of total dissolved phosphorus (TDP) from dairy WW (see FIG. 1 and Table 1 below). Phyto-available P was determined via Olsen-test and iron and micro-nutrients were determined via DTPA extract.

Table 1 indicates that maximum phytoavailable P content was obtained by loading of the Fe-WTR at a liquid to solid ratio of 3 g L⁻¹ (897±215 mg Kg⁻¹), consistent with maximal TDP removal of (8810±612 mg Kg⁻¹). The minimum phytoavailable P was obtained when the highest ratio of solid to liquid was used (15 g L⁻¹). Interestingly, the micro-nutrients availability (i.e., DTPA-extracted Fe, Cu, Mn, and Zn) increased with increasing ratio of solid to liquid. This is explained by the dairy wastewater being the P source while the metals originate in the solid fraction and with lower exposure to liquid, less metals are dissolved into the residual wastewater. Accordingly, an exemplary phosphorus enriched sorbent of the invention (e.g. P and OM enriched WTR, hereinafter Fe/O-WTR) was manufactured by loading the Fe-WTR as described hereinabove, at a liquid to solid ratio of 3 g L⁻¹

TABLE 1
Available nutrients in Fe/O—WTR and removed TP following
mixing with dairy wastewater in a number different ratios.

| Treatment | | | | | | | |
|---|---|---|---|---|---|---|---|
| Sludge | | | | | | | |
| weight to | | | | | | | |
| 1 L of | | | | | | | Removed |
| wastewater | | Olsen | DTPA | Cu | | | element |
| (gr) | N | P | Fe | mg/Kg | Mn | Zn | TP |
| 0 | 3 | 30.6 ± 0.5 | 128 ± 63 | 7.4 ± 1.4 | 32.3 ± 5.8 | 18.3 ± 3.6 | |
| 3 | 3 | 897 ± 215 | 290 ± 2.9 | 4.0 ± 0 | 38.7 ± 2.2 | 13.3 ± 1.1 | 8810 ± 612 |
| 6 | 3 | 408 ± 20.5 | 232 ± 38.7 | 5.7 ± 0.7 | 31.7 ± 3.7 | 10 ± 1.3 | 5435 ± 226 |
| 9 | 3 | 290 ± 18.7 | 306 ± 2.9 | 9.2 ± 0.6 | 39.9 ± 0.3 | 14.4 ± 0.2 | 3925 ± 42 |
| 12 | 3 | 256 ± 20.6 | 308 ± 4.3 | 11.8 ± 0.6 | 41.0 ± 1 | 14.5 ± 0.4 | 3182 ± 127 |
| 15 | 3 | 200 ± 16 | 316 ± 1.2 | 11.7 ± 0.4 | 39.4 ± 1.3 | 14.2 ± 0.5 | 2163 ± 146 |

FIG. 1 presents SRP and TDP removal percentage from the dairy wastewater in different doses of Fe-WTR per 1 L wastewater. Higher SRP removal percent in all sludge weights implies its preferred removal of inorganic orthophosphate over non-SRP species, e.g., organic P compounds. Similar and even higher SRP removal was obtained in 9, 12 and 15 g sludge with 1 L dairy wastewater, and the highest TDP removal was obtained with 12 g L⁻¹ ratio.

The full chemical composition of the Fe-WTR and of Fe/O-WTR manufactured as described hereinabove (by enrichment of Fe-WTR with dairy wastewater at a liquid to solid ratio of 3 g L⁻¹), was obtained by X-ray fluorescence analysis (XRF, semiquantitative, Bruker S2-Ranger, EDXRF, Germany) after thoroughly grinding the samples into fine-grained, homogeneous powder (see Table 1A).

TABLE 1A
a relative weight content of various oxides and
of organic matter (OM) in the untreated sorbent
(Fe-WTR) and in the enriched sorbent (Fe/O-WTR).

| | Fe - WTR | Fe/O - WTR |
|---|---|---|
| Composition | (weight %) | (weight %) |
| SiO2 | 32.75 | 28.11 |
| Fe2O3 | 11.44 | 9.02 |
| CaO | 5.69 | 7.23 |
| MgO | 5.98 | 6.03 |
| Al2O3 | 7.94 | 6.16 |
| Na2O | 6.57 | 3.59 |
| Phosphorus | 1.52 | 4.33 |
| Oxide | | |
| K2O | 1.32 | 1.17 |
| CuO | 1.11 | 1.34 |
| Other | 2.55 | 2.18 |
| OM | 24.25 | 32.22 |

Noteworthy, Table 1A represents a non-limiting chemical composition of an exemplary sorbent of the invention (Fe-WTR) and a non-limiting chemical composition of an exemplary composition of the invention (e.g. Fe/O-WTR). The exact chemical composition of the sorbent and/or of the enriched sorbent may vary, depending on the water source, concentration of various organic and/or inorganic species in the treated water, and other conditions, such as the water treatment procedure. Additionally, it should be noted that numerical values presented herein are exemplary, and not limiting in scope. Based on the extensive experimentation performed by the inventors, the phytoavailable phosphorus content of the resulting fertilizer remains almost unchanged, despite fluctuations in the chemical composition of the sorbent. Furthermore, despite fluctuations in the chemical composition of the sorbent, the resulting fertilizer contained an amount of the phytoavailable phosphorus sufficient for maintaining soil phosphate concentration being appropriate for cultivation of a plant (e.g. above 30 mg/kg, as determined by Olsen test).

Without being limited to any specific theory, it is postulated that silica is the major inorganic fraction of Fe-WTR and of Fe/O-WTR, having a relative silica content of 33 and 28% respectively, as shown in Table 1A. Furthermore, upon treatment of Fe-WTR with the wastewater (WW) the relative content of phosphorus oxide increased from 1.5% in Fe-WTR to 4.3% Fe/O-WTR (see Table 1A), thereby validating the enrichment of the sorbent with the phosphorus specie. In some embodiments, the content of phosphorus oxide in any of the compositions presented herein, refers to a total phosphorus content (TP) of the composition. Moreover, the content of the organic material (OM) increased from about 24% in Fe-WTR to about 32% in Fe/O-WTR (see Table 1A), thus validating the enrichment of the sorbent with OM upon contacting the sorbent with WW.

As represented in Table 1A, the content of other inorganic substances composing the sorbent and/or enriched sorbent of the invention, in some embodiments thereof, remained almost unchanged upon treatment of the sorbent with WW. An exemplary chemical composition of the enriched sorbent comprises about 32% of OM, about 28% of silica, between 8 and 20% of iron specie (e.g. iron oxide), between 5 and 10% calcium specie (e.g., CaO), between 1 and 10% magnesium specie (e.g. MgO) and between 4 and 5% of phosphorus oxide by weight of the composition (enriched sorbent).

### Example 2

### Phosphorus Availability in Fe-WTR and WW-Fe/O-WTR

In order to assess P bio-availability (e.g. phytoavailability) of an exemplary composition disclosed herein, the Fe/O-WTR was analyzed by performing three comparative studies: 1) 0.01 M KCl solubility, imitating the soil solution ionic strength; 2) analysis of phytoavailable species and of total P (TP) in Fe-WTR enriched with dairy wastewater (Fe/O-WTR), and 3) phosphorus sequential extraction of Fe/O-WTR.

### 1. KCl Extraction from Phosphorus Enriched Sorbents

KCl solubility was performed by extracting adsorbent with 0.01 M KCl solution and subsequently determining the phosphate concentration of the extract (via molybdenum-blue colorimetric method). The results of phosphate extraction from Fe/O-WTR were compared with Al-based WTR (Al-WTR) and with two synthetic adsorbents based on layered double hydroxide (LDH) materials: LDH Ne (commercially available adsorbent, KW 2000, Kisuma Chemicals, Netherlands), and LDH Fr.

Synthetic LDH (layered double hydroxide) composed of Mg₂Al(OH)₆Cl.nH2O (“LDHFr”) was prepared following the coprecipitation method in a reactor of 16 L, fitted to prepare amount of material greater than 1 kg in one batch. A mixed aqueous solution of MgCl2.6H2O and AlCl3.6H2O (V=6 L) with a total concentration of metal salts equal to 2 M and a Mg2+/Al3+ molar ratio equal to 2, was added at a rate of 10 mL min−1 to 4 L of deionized water. A solution of 8 M NaOH (V=3 L) was added simultaneously to maintain a pH fixed at a value of pH=10-10.5. The addition lasted 10 h and the reaction medium was continuously stirred at 80 rpm. Co-precipitation and 36 h aging of the solution-precipitate mixture was performed under N2 atmosphere to avoid carbonate contamination. After aging, the solid was recovered by 4 cycles of centrifugation and washing with CO2-free deionized water. The precipitate was dried at 40° C. in an oven. 1 kg of solid was collected.

Commercial calcined synthetic oxide material (KW2000) kindly supplied by “KISUMA CHEMICALS”, the Netherlands (“LDHNe”), containing 30-35% of Al2O3 and 57-63% of MgO corresponding to a formula Mg0.7Al0.3O1.15 with a Mg/Al molar ratio about 2.33. Once a calcined residue of a synthetic hydrotalcite is contacted with an aqueous solution, rehydration of the mixed amorphous oxide occurs and the LDH structure is partially restored. This phenomenon was originally referred as the “memory effect” of the LDH1. This behaviour was used for the intercalation of anions or organic macromolecules hard to intercalate by a simple anion exchange reaction (e.g., 2). Therefore, for simplicity, this material is termed here LDH material.

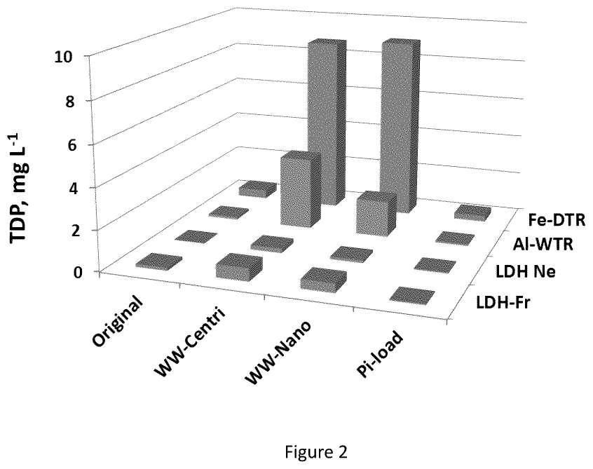

A bar graph representing TDP concentrations of the tested adsorbents is represented in FIG. 2. Adsorbents utilized in this experiment and represented in FIG. 2 were as follows: (I) untreated adsorbents (“original”), (II) enriched adsorbents formed by mixing thereof with dairy wastewater (at a liquid to solid ratio of 9 g L⁻¹), wherein the dairy wastewater was pretreated (so as to remove solids suspended therein) by either centrifugation (“WW-Centri”) or by applying nano-composite coagulants (“WW-Nano”) (such as a clay mineral poly-DADMAC composite, see for example U.S. Pat. No. 9,546,102); and (III) inorganic P-enriched adsorbents (“Pi-load”). The phosphate concentration in the wastewater and in the inorganic P pretreatment solution was about 50 mg P L⁻¹. Experimental results obtained in the experiment, clearly indicate the superiority of the Fe-WTRs over Al-WTR and/or commercially available materials. Specifically, Fe-WTR enrichment with dairy wastewater residuals resulted in the reversible binding of phosphate thereto (see FIG. 2). As demonstrated by FIG. 2, Fe/O-WTR is capable of releasing up to 3 times higher amount of phosphate (ca. 8.8 mg/L TDP), compared to Al-WTR (about 3.5 mg/L TDP). Furthermore, Fe/O-WTR exhibited between 10 and 40 times higher TDP concentration compared to the commercially available synthetic adsorbents (0.2 mg/L for LDH Ne, and 0.6 mg/L for LDH Fr).

### 2. Analysis of Phytoavailable Species in Fe/O-WTR

Phyto-available P in Fe/O-WTR significantly increased following enrichment by mixing with dairy wastewater (at a liquid to solid ratio of 3 g L⁻¹), as well as the TP (Table 2). Iron and other elements in DPTA extract are referred to as phytoavailable elements. As shown in Table 2, the phytoavailable P content of the sorbent (e.g. Fe-WTR) increased from about 30 mg/Kg in the pristine (untreated) Fe-WTR, up to about 1407 mg/Kg in the enriched sorbent (Fe/O-WTR) after performing two loading cycles with dairy wastewater. The total phosphorus weight content (TP) of the pristine (untreated) Fe-WTR was about 6 g/kg, wherein upon enrichment, the TP of the Fe/O-WTR was of about 8.8 g/kg. Moreover, the weight ratio between the phytoavailable P to the TP of the pristine (untreated) Fe-WTR was only 0.5%, wherein upon enrichment the ratio between the phytoavailable P to the TP in the Fe/O-WTR was of about 16%.

TABLE 2
Phyto-available nutrients and elements and total P (TP) and
total Fe before and after loading with dairy wastewater

| Extraction | Element | Units | Fe - WTR | Fe/O - WTR |
|---|---|---|---|---|
| Haney | P | mg Kg⁻¹ | 8.9 ± 0.9 | 350 ± 22 |
| | K | | 279 ± 52 | 472 ± 29 |
| | N | | 76 ± 9.8 | 284 ± 16 |
| | Fe | | 173 ± 4.8 | 63 ± 5.7 |
| | Zn | | 1 ± 0.01 | 3 ± 0.27 |
| | Al | | 40.8 ± 8 | 3.8 ± 0.6 |
| | Ca | | 1693 ± 85 | 1675 ± 122 |
| Olsen | P | mg Kg⁻¹ | 30.6 ± 0.4 | 1407 ± 241 |
| DPTA | Fe | mg Kg⁻¹ | 128 ± 8.9 | 290 ± 3 |
| | Mn | | 32 ± 5.8 | 38.7 ± 2.2 |
| | Zn | | 18 ± 3.6 | 13.3 ± 1.1 |
| | Cu | | 7.4 ± 1.4 | 4 ± 0 |
| Total P/Fe | TP | g Kg⁻¹ | 5.9 ± 0.13 | 8.81 ± 0.6 |
| | Total Fe | | 122 ± 0.6 | 97.4 ± 0.9 |

### 3. Phosphorus Sequential Extraction of Fe/O-WTR

Sequential extraction of P from different sorption pools with different chemical nature and solubility are presented in Table 3. In both Fe-WTR and WW-Fe/O-WTR, the highest TDP concentrations were obtained with dithionite-citrate (ca. 519 and 1984 mg kg⁻¹, respectively) (see Table 3); another relatively large P pool in Fe-WTRs was extract by MgCl₂ (ca. 137 and 956 mg kg⁻¹), while Na-acetate extracted (ca. 147 and 188 mg kg⁻¹). Following mixing with WW (at a liquid to solid ratio of 9 g L⁻¹), greatest TDP increase occurred in the dithionite-citrate and MgCl₂ extracts (1466 and 819 mg kg⁻¹ added P, respectively). Low increase in the Ca associated pools (Na-acetate and HCl extracts) was recorded (about 40-50 mg kg⁻¹). Overall, TDP and SRP concentrations extracted at each step were significantly greater in WW-Fe/O-WTR than in Fe-WTR (t values ranged from 3 to 36, n=6, p<0.05), except in NaOH-extracted SRP (t=0.17, n=6, p=0.881). Generally, inorganic phosphorus (Pi) concentrations were higher than organic phosphorus (Po) in the Fe-WTRs, although in the Fe-WTR, Po contributed an equal share to the dithionite-citrate extract as Pi (246-270 mg kg⁻¹). Following WW introduction, major Po pools remained MgCl₂ and the dithionite-citrate extracts (ca. 231 and 566 mg Po kg⁻¹, respectively), though secondary to Pi content. Accordingly, as represented in Table 3, the phytoavailable phosphorus content of the sorbent was increased by 2.4 g/kg upon enrichment with WW, from about 845 mg/kg (initial concertation of the Fe-WTR) to about 3.2 g/kg in the phosphorus enriched sorbent (Fe/O-WTR). Sequential extraction was performed as described in Zohar, et al. Environmental Technology & Innovation, 2020.

TABLE 3
Phosphorus sequential extraction in Fe-WTR and WW-Fe/O-WTR

| Extracting | Fe—WTR | | | WW—Fe/O—WTR | | | WW—TDP |
|---|---|---|---|---|---|---|---|
| solution | Pi † | Po ‡ | TDP § | Pi | Po | TDP | added ¶ |

mg kg⁻¹

| | | | | | | | |
|---|---|---|---|---|---|---|---|
| 1M MgCl₂ | 128 ± 7 | 9 | 137 ± 7 | 724 ± 70 | 232 | 956 ± 51 | 819 |
| Dithionite- | 246 ± 137 | 273 | 519 ± 26 | 1418 ± 113 | 566 | 1984 ± 300 | 1465 |
| citrate | | | | | | | |
| Na- | 200 ± 120 | n.d. | 147 ± 19 | 209 ± 62 | n.d. | 188 ± 6 | |
| acetate, | | | | | | | 41 |
| pH = 4 | | | | | | | |
| 1M HCl | 42 ± 14 | | 42 ± 14 | 96 ± 44 | | 96 ± 44 | 54 |
| Total | 616 | ≥229 | 845 | 2447 | ≥777 | 3224 | 2379 |

† Pi—inorganic P, measured as SRP,
‡ Po—organic P, calculated by subtracting SRP from total dissolved P.
§ TDP—Total dissolved P (TDP) measured following acid hydrolysis of each extracting solution.
n.d.—not determined, as standard deviation is high for the SRP, while it is possible that digestion did not result in full recovery of the TDP in this extracting solution.
¶ WW—TDP added consists of the delta between TDP in WW—Al/O—WTR and Al—WTR extracts, for each fraction.
# Whole-sample oxalate refers to non-sequential extraction of whole sample with 0.175M oxalate solution.
†† TP—Total P.

### Example 3

### Phosphorus and Iron Uptake in Fruit and in the Whole Plant

In a pot experiment, tomato (Lycopersicon esculentum) growth was tested in different treatments: control (no P addition); solid fertilizer (commercial P solid fertilizer, “Osmocote 3-4”); and exemplary compositions of the invention: (I) Fe/O-WTR in 100 g per 10 L dose (FeO_100) and (II) Fe/O-WTR in 150 g per 10 L dose (FeO_150). All treatments received N, K, Cu, Mn, and Zn through the irrigating water in identical levels. Noteworthy, the total phosphorus content of the solid fertilizer was of about 3.7 g/kg fertilizer, wherein the total phosphorus content of the exemplary composition of the invention (e.g. Fe/O-WTR) implemented in this experiment was of about 0.9 g/kg. Therefore, the addition of the external phosphorus per each pot was of 3.7 g for the solid fertilizer, compared to a significantly lower addition (about ⅓) of the external phosphorus (0.9 or 1.4 g/kg for FeO_100 and FeO_150, respectively, see Table 4). Fe/O-WTR implemented in this experiment was obtained by enrichment of Fe-WTR with dairy wastewater at a liquid to solid ratio of 3 g L⁻¹, as described herein.

As represented by Table 4, phosphorus uptake values into the fruit upon application of (i) the solid fertilizer, and (ii) the exemplary compositions of the invention (FeO_100 and FeO_150) were significantly higher than the control treatment. Furthermore, the application of the solid fertilizer and FeO_150 resulted in the highest P content in the fruit (about 7.2 g). Similar results were obtained for P uptake by the whole plant, resulting in the plant P content of about 7.5 g for FeO_150 treatment.

Nevertheless, with respect to the total P content added to each pot, the composition(s) of the invention exhibited a significantly higher efficiency by reducing phosphorus misuse, and at the same time inducing a phosphorus plant uptake comparable to the plant uptake with the solid fertilizer.

TABLE 4
Phosphorus external input, uptake and their ratio in
tomato fruit and whole plant in different treatments

| | P external | | P plant/ | | P plant/ |
|---|---|---|---|---|---|
| | input in | P uptake | P reservoir | | P reservoir |
| | pot | Fruit | | Whole plant | |
| Treatment | g | g | | g | |
| Control | | 5.91 | | 6.26 | |
| | | (0.38) | | (0.43) | |
| Solid Fert. | 3.666 | 8.57 | 0.89 | 9.09 | 0.92 |
| | | (1.13) | | (1.14) | |
| FeO_{†}_{_{—}}100 | 0.918 | 6.83 | 1.00 | 7.14 | 0.99 |
| | | (0.31) | | (0.32) | |
| FeO_150 | 1.377 | 7.23 | 0.99 | 7.48 | 0.98 |
| | | (0.76) | | (0.76) | |

As to the efficiency of phosphorus uptake from soil reservoir, the Fe/O-WTR treatments display a higher P plant/reservoir ratio (about 1, see Table 4), suggesting a better availability and accessibility of P in the WW-Fe/O-WTR treatments compared to the solid fertilizer showing P plant/reservoir ratio of about 0.9.

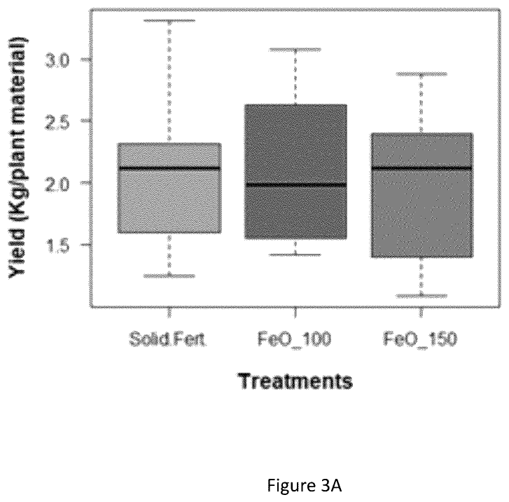

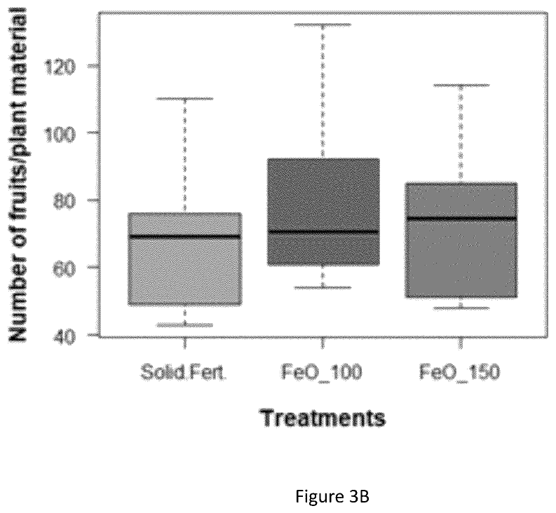

Tomato yield and the number of tomato fruits are represented in FIGS. 3A and 3B. Fe/O-WTR treatment resulted in a similar crop yield compared to the solid fertilizer, indicating that the composition of the invention having only ⅓ of the TP content of commercially available fertilizer, is significantly more efficient.

### Example 4

### Phosphorus and Iron Incorporation into the Soil

In a pot experiment, tomato (Lycopersicon esculentum) growth was tested in different treatments: control (no P addition); solid fertilizer (commercial P solid fertilizer, “Osmocote 3-4”); WW-Fe/O-WTR in 100 g per 10 L dose (FeO_100) and WW-Fe/O-WTR in 150 g per 10 L dose (FeO_150). All treatments received N, K, Cu, Mn, and Zn through the irrigating water in identical levels.

Residual phytoavailable nutrients concentrations in the soil, at the end of the experiment, are presented in Table 5. The soil treated with the solid fertilizer clearly attains higher phytoavailable phosphorus, compared to other treatments, after the end of the growing season. Such high soil phosphate concentration is significantly greater than the optimal phosphate concentration required for the cultivation. Consequently, phosphorus application through conventional solid fertilizer results in an inadequate usage of a scarce resource like phosphorus. Noteworthy, the total phosphorus content of the exemplary composition of the invention was only ⅓ of the total phosphorus content of the solid fertilizer, as described hereinabove.

The treatments by the composition(s) of the invention resulted in less than 50% of the phytoavailable phosphorus compared to the solid fertilizer. However, the composition(s) of the invention significantly increased the phytoavailable phosphorus content of the soil compared to the control, and also contributed to the increased K and Fe concentration, especially for FeO_150 treatment. Residual phytoavailable N concentration was also much higher than other treatments, at the end of the growing season.

TABLE 5
Residual phytoavailable nutrients soil concentrations at the
end of the growing season in tomato growing pot experiment.

| | | | | |
|---|---|---|---|---|
| Treatment | Olsen P | Haney K | Haney N | DTPA Fe |

mg kg⁻¹

| | | | | |
|---|---|---|---|---|
| Beginning | 148 ± 3 | ±6.243.6 | 83.6 ± 3.9 | 13.1 ± 0.03 |
| Control | 65.93 ± 2.45 | 300 ± 10.71 | 92.02 ± 8.55 | 28.84 ± 1.59 |
| Solid Fert. | 229 ± 5.35 | 157 ± 13.23 | 161 ± 19.39 | 29.07 ± 0.82 |
| FeO_100 | 82.99 ± 3.46 | 357 ± 9.44 | 82.24 ± 9.57 | 30.11 ± 2.37 |
| FeO_150 | 89.82 ± 4.25 | 371 ± 30.08 | 79.38 ± 4.5 | 37.46 ± 2.14 |

Accordingly, the composition of the invention is capable to reduce the amount of phosphorus applied to the cultivation area (e.g. by 50 to 70%), thus preventing phosphorus misuse and phosphorus pollution of the environment (e.g. eutrophication). Without being limited to any particular theory, the compositions and/or fertilizers disclosed herein containing up to 5% by weight of the total phosphorus, have been successfully implemented as fertilizers, wherein the commercially available solid fertilizers require a total phosphorus content of about 20% by weight.

### Example 5

### Treatment of Contaminated Wastewater

Dairy wastewater (WW) contaminated with phosphate was first clarified from rough solids by primary sedimentation, after which it had averaged values of 7.36 pH, 6.8 mS cm⁻¹ EC, 314 mg L⁻¹ of total N (TN), about 50 mg L⁻¹ phosphate (P), TSS range of 160-690 mg L⁻¹ and ca. 3285 mg L⁻¹ of dissolved organic carbon (DOC). Further clarification was performed either by centrifugation (“centri”; 5000 rpm, 30 min, 4° C.) or by nanocomposites (NC) based coagu-flocculation process (“nano”).

Dairy wastewater was clarified from the suspended solids as follows:

Nano-composite, (a suspension prepared by mixing of 10 g L⁻¹ sepiolite and 18 g L−1 poly-DADMAC (PD), supplied by Chemicals to Israel), was added to a volume of 1 cubic meter of wastewater (after a preliminary sedimentation pond) in a rate of 0.12% (i.e. 1.2 L added to 1 m³ WW). Exact conditions for the preparation of NC are as described in WO2012176190 or in WO2017158581.

A preliminary jar-test was performed to determine the exact rate of NC dose added to 1 m³ of dairy wastewater.

The suspension is rapidly mixed for about 5 minutes. Then a bridging polymer, Z-tag (0.12% addition rate), is added and the suspension is mixed for another 15 minutes.

At the next stage, the suspension is transferred to a decantation tank, where clear solution is decanted and gathered, while solids in the form of big flocs precipitate to the floor of the tank and are separated.

The sorption experiment, by-which four solid adsorbents were enriched with P from dairy WW followed the protocol of Zohar et al. “Innovative approach for recycling phosphorous from agro-wastewaters using water treatment residuals (WTR). Chemosphere 168, 234-243 (2017). Specifically, 9 g of solids were mixed with 1 L of either WW-centri or WW-nano on an end-to-end shaker for three days, to allow adsorption saturation in equilibrium conditions. Solids were separated from liquids by centrifugation (5000 rpm, 30 min, 4° C.) and were designated by the prefix WW (e.g., “WW-LDHNE”). A set of Pi loaded adsorbents was prepared at the same manner, with initial P concentration like the clarified WW (i.e., 50 mg P L−1), using K2HPO4 and were designated by the prefix Pi (e.g., “Pi-Al-WTR”).

Before and after mixture with the adsorbents, the WWs were analyzed for the following parameters: soluble reactive P (SRP; represents the orthophosphate (Pi) species, H2PO4−, HPO42−, PO43−, interchanging with pH), (Auto analyzer Skalar S++, the Netherlands, following the molybdenum-blue method); dissolved organic carbon (DOC) and total N (TN) (TOC/TN analyzer, multi N/C® 2100/2100 S, Germany); metals (Ca, Mg, Fe, Al) and total P (inductively coupled plasma optical emission spectroscopy (ICP-OES), Varian Liberty RL sequential ICP-OES, Australia). Non-SRP Removal was calculated by subtracting SRP from total dissolved P (TDP).

Clarification efficiency of WW is strongly dependent on the processes used, particularly when aiming to optimize phosphate recovery, while removing non-valuable wastes. Indeed, using two different clarification pre-treatments, a physical solid-solution separation by centrifugation and a physico-chemical treatment based on nanocomposites addition, resulted in somewhat different SRP concentrations (41.24±0.57 mg SRP L⁻¹ and 62.24±1.72 mg SRP L⁻¹ in the WW-centri and WW-nano, respectively); non-SRP levels in the pre-treated dairy WW were relatively low and similar (slightly above 8 mg L⁻¹ see Table 7). Considering similar suspended-solid clarification capabilities, the nano-composites pre-treatment was able to maintain a higher level (51% higher content) of SRP in the treated WW. The term “SRP” refers to inorganic phosphorus specie(s) (e.g. orthophosphate), whereas the term “TDP” refers to a sum of SRP and non-SRP (e.g. organic phosphorus specie(s)).

Next, adsorbents contacted with the clarified WW yielded clear differences in P sorption performance (Tables 1-3). The synthetic materials usually recovered over 99% of the SRP from the WW, with LDHNE performed slightly better than LDHFr. The former commercial product is a calcined hydrotalcite, which displays a higher specific surface area (BET) of 155-255 m²g⁻¹ (technical data from Kisumi Chem.) compared to Cl− exchanged hydrotalcite (<70 m²g⁻¹). LDH adsorbents removed higher P levels from the WW-nano than from WW-centri (over 6800 mg kg⁻¹ and about 4500 mg kg⁻¹, respectively). The extremely high P adsorption capacity of both synthetic LDH materials appears to be unsaturated still, since Mg₂Al—Cl LDH displays theoretical anion exchange capacity for HPO₄²⁻ equal to 65.1 g kg⁻¹, values much higher than the mass recovered under this experiment, considering that at least adsorption is insured by anion exchange reaction. Importantly, these materials are very selective to phosphate.

SRP sorption by the recycled materials was not as good as by the synthetic materials (see Table 6). Al-WTR recovered 51% (2346 mg Kg⁻¹) and 60% (4160 mg Kg⁻¹) SRP from the WW-centri and WW-nano, respectively). The Fe-DTR performed better and removed 64% (2937 mg Kg⁻¹) and 80% (5514 mg Kg⁻¹) SRP from the WW-centri and WW-nano, respectively.

In both the Al-WTR and Fe-DTR, precipitation plays an important role in P sequestration in addition to adsorption, in the Al-WTR even more than in the Fe-WTR. P sorption might be affected by ambient conditions such as by varying ambient day/night temperature in winter versus ambient day/night temperature in summer (usually above 25° C.). Since P sorption was shown to increase with temperature, it is postulated that lower temperature will result in increased soluble P. It is further postulated, that precipitation and adsorption mechanisms are more sensitive to low temperatures than ion exchange.

The gap between the performance of the Al-WTR and Fe-DTR was even larger with increased levels of TDP in the WW-nano, implying that wastewater pretreatment by NC had a positive synergistic effect on P adsorption sites in Fe-DTR (e.g. Fe hydr(oxides)). Phosphorus removal from the WW-Nano was higher in absolute and percentage values for both the Al-WTR and Fe-DTR, as was found for the synthetic materials. Non-SRP, usually representing organic P moieties, displayed similar removal as the SRP: LDH adsorbents removed non-SRP in better efficiency than WTR adsorbents and usually more non-SRP was removed from the WW-nano. P removal appears much more efficient with the WW-nano, while these diary WW contained a higher P rate. It is postulated, that competitive processes occur when dealing with WW-centri that result in lower P removal, and/or residual polymers in WW-nano enhance P sorption, highlighting the advantage of the nanocomposite treatment of dairy WW for P recovery.

TABLE 6
Phosphorus concentrations in WWs, in residual effluents and
removal rates, following mixing with sorbing materials.

| | Residual | | Re- | Re- | Re- | Non-SRP |
|---|---|---|---|---|---|---|
| | SRP (s.d.) | | moval | moval | moval | Removal |
| | mg L⁻¹ | | mg L⁻¹ | % | mg kg⁻¹ | mg kg⁻¹ |
| WW-Centri | 41.23 | (0.57) | | | | |
| LDHFrc | 0.84 | (0.14) | 40.39 | 98.0% | 4488.2 | 734.0 |
| LDHNec | 0.06 | (0.03) | 41.17 | 99.9% | 4574.4 | 828.9 |
| Al-WTRc | 20.12 | (0.29) | 21.11 | 51.2% | 2346.1 | 462.6 |
| Fe-WTRc | 14.80 | (1.39) | 26.43 | 64.1% | 2936.7 | 396.6 |
| WW- Nano | 62.24 | (1.72) | | | | |
| LDHFrn | 0.44 | (0.22) | 61.80 | 99.3% | 6866.8 | 778.9 |
| LDHNen | 0.19 | (0.05) | 62.05 | 99.7% | 6894.7 | 857.2 |
| Al-WTRn | 24.80 | (0.43) | 37.44 | 60.2% | 4160.0 | 370.9 |
| Fe-WTRn | 12.61 | (0.12) | 49.63 | 79.7% | 5514.1 | 584.7 |

Table legend: SRP—soluble reactive P; s.d.—standard deviation; WW-centri—dairy wastewater pre-treated with centrifugation for clarification; WW-nano—dairy WW pre-treated with nanocomposites for clarification; LDH—layered double hydroxides; Al-WTR—Al water treatment residuals; Fe-WTR—Fe desalination water treatment residuals. Suffixes c and n indicate an adsorbent reacted with WW-centri and WW-nano, respectively.

TABLE 7
Total dissolved P in Dairy WW before and after the adsorption
experiment and the removed or dissolved TDP

| | TDP WW-Centri (s.d.) | | | | TDP WW-Nano (s.d.) | | | |
|---|---|---|---|---|---|---|---|---|
| | mg L⁻¹ | | | | mg L⁻¹ | | | |
| | 49.78 | | | | 70.44 | | | |
| | Residual | | Removal (+)/ | | Residual | | Removal (+)/ | |
| | conc. | | dissolution (−) | | conc. | | dissolution (−) | |
| | mg L−¹ | | mg kg−¹ | | mg L−¹ | | mg kg−¹ | |
| LDH Fr | 2.78 | (0.15) | 5222.2 | (16.6) | 1.63 | (0.28) | 7645.7 | (31.4) |
| LDH Ne | 1.15 | (0.05) | 5403.3 | (5.6) | 0.68 | (0.08) | 7751.9 | (8.7) |
| Al-WTR | 24.50 | (0.24) | 2808.6 | (26.2) | 29.67 | (n.d.) | 4530.9 | (n.d.) |
| Fe-DTR | 19.78 | (1.89) | 3333.3 | (209.5) | 15.56 | (n.d.) | 6098.8 | (n.d.) |

TDP—Total dissolved P; s.d.—standard deviation; WW-centri—dairy wastewater pre-treated with centrifugation for clarification; WW-nano—dairy WW pre-treated with nanocomposites for clarification; LDH—layered double hydroxides; Al-WTR—Al water treatment residuals; Fe-DTR—Fe desalination water treatment residuals.

To this end, it has been exemplified that by implementing the method of the invention including NC pretreatment and subsequent sorption step with a P-sorbent, it is possible to substantially remove TSS and additionally dissolved inorganic species (e.g. TDP, metals such as Fe), and dissolved organic species from wastewater, thereby obtaining treated water. Treated water can be further recycled (e.g. in the agriculture). Alternatively, the treated water is subsequently subjected to a disinfection step (by contacting thereof with a disinfectant) so as to obtain potable water.

### General

As used herein the term “about” refers to ±10%.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

As used herein, the term “substantially” refers to at least 80%, at least 85%, at least 90%, at least 92%, at least 95%, at least 96%, at least 97%, at least 98%, at least 99%, including any range or value therebetween.

As used herein, the term “enhance” including any grammatical forms thereof, refers to least 10%, at least 20%, at least 30%, at least 40%, at least 50%, at least 60%, at least 70%, at least 100%, between 100 and 200%, between 200 and 300%, between 300 and 500%, between 500 and 1000%, between 1000 and 10000% including any range between, compared to a control.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

1-38. (canceled)

39. A fertilizer, comprising a fertilizing effective amount of a composite comprising a sorbent enriched with organic material comprising a phosphorus specie, wherein:
said sorbent comprises between 5 and 40% of an iron specie, between 5 and 50% of a calcium specie, and optionally at most 9% of aluminum specie by total dry weight of said sorbent;
said composite comprises:
between 5 and 40% of organic material; and
between 1 and 10% of the phosphorus specie; wherein at least 10% w/w of said phosphorus specie is phytoavailable.

40. The fertilizer of claim 39, wherein said sorbent comprises at least 50% water treatment residuals (WTR) by dry weight of said sorbent.

41. The fertilizer of claim 39, wherein said sorbent further comprises at least one of (i) between 0.1 and 5% of a magnesium specie, and (ii) between 10 and 40% of silica, by total dry weight of said sorbent; and wherein any one of said iron specie, said calcium specie and said aluminum specie is selected from the group consisting of a metal oxide, a metal hydroxide, and a metal salt or any combination thereof; and wherein said composite is in from of a particulate matter.

42. The fertilizer of claim 41, wherein said magnesium specie comprises magnesium oxide, magnesium hydroxide, a magnesium salt, or any combination thereof.

43. The fertilizer of claim 41, wherein said particulate matter has an average particle size between 10 μm and 1000 μm.

44. The fertilizer of claim 41, wherein said fertilizing effective amount comprises between 0.1 and 50 ton of said composite to a hectare soil.

45. The fertilizer of claim 39, wherein said phosphorus specie comprises an inorganic phosphate, an organic phosphate or both; optionally wherein said inorganic phosphate is selected from the group consisting of: a phosphate, a diphosphate, and a triphosphate including any combination or a salt thereof; optionally wherein said organic phosphate is selected from the group consisting of: a phosphate ester, a phosphodiester, and a phosphotriester, including any combination or a salt thereof.

46. The fertilizer of claim 39, wherein a water content of said composite is between 0.1 and 10%; wherein at least 90% w/w of said phosphorus specie is stably bound to said sorbent.

47. The fertilizer of claim 39, wherein at least 50% w/w of said phosphorus specie is phytoavailable.

48. The fertilizer of claim 39, further comprising at least one of N and K, including any salt or a derivative thereof.

49. The fertilizer of claim 39, further comprising a micro element selected from the group consisting of Mg, Ca, S, Fe, Mn, Zn, B, Cu, Mo, and Si, including any salt, a derivative or a combination thereof; and an agriculturally acceptable carrier; and
wherein said fertilizer is capable of enhancing (i) a plant yield, (ii) a plant growth or both (i) and (ii), and wherein said enhancing is by at least 10% compared to a control.

50. The fertilizer of claim 39, characterized by an enhanced release of the phosphorus specie upon contacting said fertilizer with a soil, wherein said enhanced release is greater by at least 10% compared to a control.

51. A method for treating water contaminated with a phosphorus specie, comprising contacting said water with a sorbent under appropriate conditions, thereby reducing a content of said phosphorus specie within said water; wherein said sorbent comprises between 5 and 40% of an iron specie, between 5 and 50% of a calcium specie, and optionally at most 9% of aluminum specie by total dry weight of said sorbent, and wherein said sorbent comprises at least 50% water treatment residuals (WTR) by dry weight of said sorbent.

52. The method of claim 51, wherein said sorbent further comprises at least one of (i) between 0.1 and 5% of a magnesium specie, and (ii) between 10 and 40% of silica, by total dry weight of said sorbent; and wherein said appropriate conditions comprise (i) incubation time sufficient for reducing the content of said of said phosphorus specie within said water by at least 50%, (ii) temperature of between 5 and 50° C.

53. The method of claim 51, wherein said contacting comprises agitating said water with said sorbent and wherein said method is for enriching said sorbent with said phosphorus specie.

54. A method for enriching a soil with an element, comprises contacting a fertilizing effective amount of a fertilizer of claim with said soil; wherein said fertilizer, comprises a fertilizing effective amount of a composite comprising a sorbent enriched with organic material comprising a phosphorus specie, wherein:
said sorbent comprises between 5 and 40% of an iron specie, between 5 and 50% of a calcium specie, and optionally at most 9% of aluminum specie by total dry weight of said sorbent;
said composite comprises:
between 5 and 40% of organic material; and
between 1 and 10% of the phosphorus specie; wherein at least 10% w/w of said phosphorus specie is phytoavailable.

55. The method of claim 54, wherein said element is selected from the group consisting of P, Fe, N and K including any salt or a combination thereof; and wherein said element is a phytoavailable element.

56. The method of claim 54, wherein said enriching comprises increasing a w/w concentration of said element within said soil by at least 10% compared to a solid fertilizer with the same total phosphorus content.

57. The method of claim 54, wherein said method is for increasing a concentration of said element within a plant or a part of said plant; and wherein said method is for increasing any one of: (i) a yield of a plant, (ii) a growth of a plant or both (i) and (II).

58. The method of claim 54, wherein said fertilizing effective amount is between 0.1 and 50 ton/Hectare.
